(19) United States
(12) Patent Application Publication
(10) Pub. No.: US 2006/0218628 A1
(43) Pub. Date: Sep. 28, 2006

(54) Method and system for enhanced federated single logout

(76) Inventors: Heather Maria Hinton, Austin, TX (US); Dolapo Martin Falola, Austin, TX (US); Jose A. Rodriguez, Cayey, PR (US)

Correspondence Address: IBM CORP (JRB);C/O LAW OFFICE OF JOSEPH R BURWELL, P O BOX 28022, AUSTIN, TX, 78755-8022, US

(21) Appl. No.: 11/086,717

(22) Filed: Mar. 22, 2005

(51) Int. Cl. G06F 17/30

(52) U.S. Cl. 726/8

(57) ABSTRACT

A method is presented in which computing environments of different enterprises interact within a federated computing environment. Federated operations can be initiated at the computing environments of federation partners on behalf of a user at a different federated computing environment. A first domain and a second domain, which are federated entities within the federated environment, can initiate a logout operation at the other domain on behalf of a user as part of a federated single-sign-off operation. In a generalized single-sign-off operation, a first domain generates a list of domains with which the first domain has participated in a single-sign-on operation on behalf of the user and sends to those domains a logoff request message in order to logoff the user at each domain. A logoff response message contains at least one error code that indicates information about a reason for a failure to logoff the user at the respective domain.

### BACKGROUND OF THE INVENTION

1. Field of the Invention

The present invention relates to an improved data processing system and, in particular, to a method and apparatus for multicomputer data transferring. Still more particularly, the present invention is directed to networked computer systems.

2. Description of Related Art

Enterprises generally desire to provide authorized users with secure access to protected resources in a user-friendly manner throughout a variety of networks, including the Internet. Although providing secure authentication mechanisms reduces the risks of unauthorized access to protected resources, those authentication mechanisms may become barriers to accessing protected resources. Users generally desire the ability to change from interacting with one application to another application without regard to authentication barriers that protect each particular system supporting those applications.

As users get more sophisticated, they expect that computer systems coordinate their actions so that burdens on the user are reduced. These types of expectations also apply to authentication processes. A user might assume that once he or she has been authenticated by some computer system, the authentication should be valid throughout the user's working session, or at least for a particular period of time, without regard to the various computer architecture boundaries that are almost invisible to the user. Enterprises generally try to fulfill these expectations in the operational characteristics of their deployed systems, not only to placate users but also to increase user efficiency, whether the user efficiency is related to employee productivity or customer satisfaction.

More specifically, with the current computing environment in which many applications have a Web-based user interface that is accessible through a common browser, users expect more user-friendliness and low or infrequent barriers to movement from one Web-based application to another. In this context, users are coming to expect the ability to jump from interacting with an application on one Internet domain to another application on another domain without regard to the authentication barriers that protect each particular domain. However, even if many systems provide secure authentication through easy-to-use, Web-based interfaces, a user may still be forced to reckon with multiple authentication processes that stymie user access across a set of domains. Subjecting a user to multiple authentication processes in a given time frame may significantly affect the user's efficiency.

For example, various techniques have been used to reduce authentication burdens on users and computer system administrators. These techniques are generally described as “single-sign-on” (SSO) processes because they have a common purpose: after a user has completed a sign-on operation, i.e. been authenticated, the user is subsequently not required to perform another authentication operation. Hence, the goal is that the user would be required to complete only one authentication process during a particular user session.

To reduce the costs of user management and to improve interoperability among enterprises, federated computing spaces have been created. A federation is a loosely coupled affiliation of enterprises which adhere to certain standards of interoperability; the federation provides a mechanism for trust among those enterprises with respect to certain computational operations for the users within the federation. For example, a federation partner may act as a user's home domain or identity provider. Other partners within the same federation may rely on the user's identity provider for primary management of the user's authentication credentials, e.g., accepting a single-sign-on token that is provided by the user's identity provider.

As enterprises move to support federated business interactions, these enterprises should provide a user experience that reflects the increased cooperation between two businesses. As noted above, a user may authenticate to one party that acts as an identity provider and then single-sign-on to a federated business partner that acts as a service provider. However, only part of securing a system is the requirement that a user complete an authentication operation to prove their identity to the system. An equally important part of this process is the requirement that a user complete a logoff operation in order to end a secure session, thereby preventing other users from stealing or otherwise maliciously interfering with a valid session. Hence, in conjunction with single-sign-on functionality, additional user lifecycle functionality, such as single-sign-off, should also be supported.

Single-sign-off solutions have been described within some federation specification standards, such as the WS-Federation specifications and the Liberty Alliance specifications. While they describe how to implement a single-sign-off solution, they do not adequately address how to complete the process; for example, if there are errors in the single-sign-off processing, these specifications do not adequately how to recover nor how to notify the user of the overall status of the single-sign-off process.

This is problematic because there may be situations when an identity provider, as part of a single-sign-on, assumes liability for a user's actions across a group of federation partners. If the identity provider cannot successfully log a user out of all of this group of partners and cannot notify the user of this status, then the identity provider must retain some level of responsibility for the user's sessions at those partners. This can also be problematic in situations in which a user is accessing a federation relationship through a public Internet kiosk.

In addition, while the Liberty Alliance specifications allow for a service-provider-initiated single logout (SLO), this process requires the service provider to initiate a single logout request at the identity provider and the identity provider to respond with a status of this process to the service provider. This solution does not allow an identity provider to accurately reflect the overall status of the single logout request.

Therefore, it would be advantageous to have methods and systems in which enterprises can provide comprehensive single-sign-off or single-logout experiences to users in a federated computing environment.

### SUMMARY OF THE INVENTION

A method, a system, an apparatus, and a computer program product are presented to support computing environments of different enterprises that interact within a federated computing environment. Federated operations can be initiated at the computing environments of federation partners on behalf of a user at a different federated computing environment. A first domain and a second domain, which are federated entities within the federated environment, can initiate a logout operation at the other domain on behalf of a user as part of a federated single-sign-off operation. In a generalized single-sign-off operation, a first domain generates a list of domains with which the first domain has participated in a single-sign-on operation on behalf of the user and sends to those domains a logoff request message in order to logoff the user at each domain. A logoff response message contains at least one error code that indicates information about a reason for a failure to logoff the user at the respective domain.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 1C depicts a data flow diagram that illustrates a typical authentication process that may be used when a client attempts to access a protected resource at a server;

FIG. 1D depicts a network diagram that illustrates a typical Web-based environment in which the present invention may be implemented;

FIG. 1E depicts a block diagram that illustrates an example of a typical online transaction that might require multiple authentication operations from a user;

FIG. 2 depicts a block diagram that illustrates the terminology of the federated environment with respect to a transaction that is initiated by a user to a first federated enterprise, which, in response, invokes actions at downstream entities within the federated environment;

FIG. 3 depicts a block diagram that illustrates the integration of pre-existing data processing systems at a given domain with some federated architecture components that may be used to support an embodiment of the present invention;

FIG. 4 depicts a block diagram that illustrates an example of a manner in which some components within a federated architecture may be used to establish trust relationships to support an implementation of the present invention;

FIG. 5 depicts a block diagram that illustrates an exemplary set of trust relationships between federated domains using trust proxies and a trust broker in accordance with an exemplary federated architecture that is able to support the present invention;

FIG. 6 depicts a block diagram that illustrates a federated environment that supports federated single-sign-on operations;

FIG. 7 depicts a block diagram that illustrates some of the components in a federated domain for implementing federated user lifecycle management functionality in order to support the present invention;

FIG. 8 depicts a dataflow diagram that illustrates an enhanced, identity-provider-initiated, federated single-sign-off operation in accordance with an embodiment of the present invention;

FIG. 9 depicts a dataflow diagram that illustrates an enhanced, service-provider-initiated, federated single-sign-off operation in accordance with an embodiment of the present invention;

FIG. 10A-10C depicts a dataflow diagram that illustrates an enhanced, identity-provider-initiated, federated single-sign-off operation wherein the identity provider handles error conditions that are generated during the single-sign-off operation in accordance with an embodiment of the present invention; and

FIG. 11 depicts an information window within a graphical user interface illustrates a manner in which an identity provider informs a user of the status of a single-sign-off operation based on enhanced error code values that have been returned by one or more service providers during the single-sign-off operation in accordance with the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

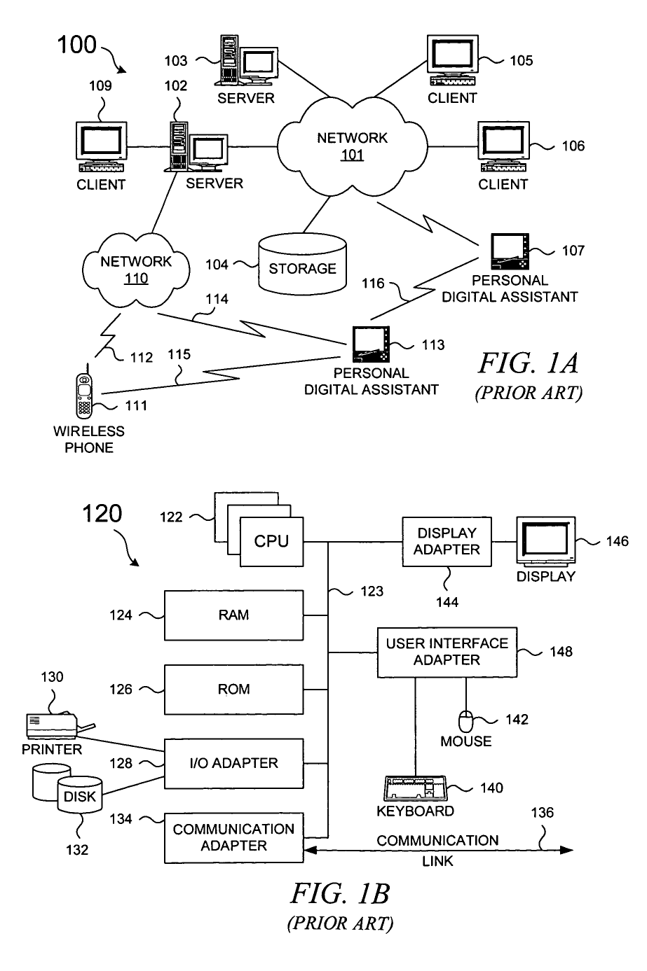

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. It should also be noted that the distributed data processing system shown in FIG. 1A is contemplated as being fully able to support a variety of peer-to-peer subnets and peer-to-peer services.

With reference now to FIG. 1C, a data flow diagram illustrates a typical authentication process that may be used when a client attempts to access a protected resource at a server. As illustrated, the user at a client workstation 150 seeks access over a computer network to a protected resource on a server 151 through the user's web browser executing on the client workstation. A protected or controlled resource is a resource (an application, an object, a document, a page, a file, executable code, or other computational resource, communication-type resource, etc.) for which access is controlled or restricted. A protected resource is identified by a Uniform Resource Locator (URL), or more generally, a Uniform Resource Identifier (URI), that can only be accessed by an authenticated and/or authorized user. The computer network may be the Internet, an intranet, or other network, as shown in FIG. 1A or FIG. 1B, and the server may be a web application server (WAS), a server application, a servlet process, or the like.

The process is initiated when the user requests a server-side protected resource, such as a web page within the domain “ibm.com” (step 152). The terms “server-side” and “client-side” refer to actions or entities at a server or a client, respectively, within a networked environment. The web browser (or associated application or applet) generates an HTTP request (step 153) that is sent to the web server that is hosting the domain “ibm.com”. The terms “request” and “response” should be understood to comprise data formatting that is appropriate for the transfer of information that is involved in a particular operation, such as messages, communication protocol information, or other associated information.

The server determines that it does not have an active session for the client (step 154), so the server initiates and completes the establishment of an SSL (Secure Sockets Layer) session between the server and the client (step 155), which entails multiple transfers of information between the client and the server. After an SSL session is established, subsequent communication messages are transferred within the SSL session; any secret information remains secure because of the encrypted communications within the SSL session.

However, the server needs to determine the identity of the user before allowing the user to have access to protected resources, so the server requires the user to perform an authentication process by sending the client some type of authentication challenge (step 156). The authentication challenge may be in various formats, such as an HTML form. The user then provides the requested or required information (step 157), such as a username or other type of user identifier along with an associated password or other form of secret information.

The authentication response information is sent to the server (step 158), at which point the server authenticates the user or client (step 159), e.g., by retrieving previously submitted registration information and matching the presented authentication information with the user's stored information. Assuming the authentication is successful, an active session is established for the authenticated user or client. The server creates a session identifier for the client, and any subsequent request messages from the client within the session would be accompanied by the session identifier.

The server then retrieves the originally requested web page and sends an HTTP response message to the client (step 160), thereby fulfilling the user's original request for the protected resource. At that point, the user may request another page within “ibm.com” (step 161) by clicking a hypertext link within a browser window, and the browser sends another HTTP request message to the server (step 162). At that point, the server recognizes that the user has an active session (step 163) because the user's session identifier is returned to the server in the HTTP request message, and the server sends the requested web page back to the client in another HTTP response message (step 164). Although FIG. 1C depicts a typical prior art process, it should be noted that other alternative session state management techniques may be depicted, such as URL rewriting or using cookies to identify users with active sessions, which may include using the same cookie that is used to provide proof of authentication.

With reference now to FIG. 1D, a diagram illustrates a typical Web-based environment in which the present invention may be implemented. In this environment, a user of browser 170 at client 171 desires to access a protected resource on web application server 172 in DNS domain 173, or on web application server 174 in DNS domain 175.

In a manner similar to that shown in FIG. 1C, a user can request a protected resource at one of many domains. In contrast to FIG. 1C, which shows only a single server at a particular domain, each domain in FIG. 1D has multiple servers. In particular, each domain may have an associated authentication server 176 and 177.

In this example, after client 171 issues a request for a protected resource at domain 173, web application server 172 determines that it does not have an active session for client 171, and it requests that authentication server 176 perform an appropriate authentication operation with client 171. Authentication server 176 communicates the result of the authentication operation to web application server 172. If the user (or browser 170 or client 171 on behalf of the user) is successfully authenticated, then web application server 172 establishes a session for client 171 and returns the requested protected resource. Typically, once the user is authenticated by the authentication server, a cookie may be set and stored in a cookie cache in the browser. FIG. 1D is merely an example of one manner in which the processing resources of a domain may be shared amongst multiple servers, particularly to perform authentication operations.

In a similar manner, after client 171 issues a request for a protected resource at domain 175, authentication server 177 performs an appropriate authentication operation with client 171, after which web application server 174 establishes a session for client 171 and returns the requested protected resource. Hence, FIG. 1D illustrates that client 171 may have multiple concurrent sessions in different domains yet is required to complete multiple authentication operations to establish those concurrent sessions.

With reference now to FIG. 1E, a block diagram depicts an example of a typical online transaction that might require multiple authentication operations from a user. Referring again to FIG. 1C and FIG. 1D, a user may be required to complete an authentication operation prior to gaining access to a controlled resource, as shown in FIG. 1C. Although not shown in FIG. 1C, an authentication manager may be deployed on server 151 to retrieve and employ user information that is required to authenticate a user. As shown in FIG. 1D, a user may have multiple current sessions within different domains 173 and 175, and although they are not shown in FIG. 1D, each domain may employ an authentication manager in place of or in addition to the authentication servers. In a similar manner, FIG. 1E also depicts a set of domains, each of which support some type of authentication manager. FIG. 1E illustrates some of the difficulties that a user may experience when accessing multiple domains that require the user to complete an authentication operation for each domain.

User 190 may be registered at ISP domain 191, which may support authentication manager 192 that authenticates user 190 for the purpose of completing transactions with respect to domain 191. ISP domain 191 may be an Internet Service Provider (ISP) that provides Internet connection services, email services, and possibly other e-commerce services. Alternatively, ISP domain 191 may be an Internet portal that is frequently accessed by user 190.

Similarly, domains 193, 195, and 197 represent typical web service providers. Government domain 193 supports authentication manager 194 that authenticates users for completing various government-related transactions. Banking domain 195 supports authentication manager 196 that authenticates users for completing transactions with an online bank. E-commerce domain 197 supports authentication manager 198 that authenticates users for completing online purchases.

As noted previously, when a user attempts to move from one domain to another domain within the Internet or World Wide Web by accessing resources at the different domains, a user may be subjected to multiple user authentication requests or requirements, which can significantly slow the user's progress across a set of domains. Using FIG. 1E as an exemplary environment, user 190 may be involved in a complicated online transaction with e-commerce domain 197 in which the user is attempting to purchase an on-line service that is limited to users who are at least 18 years old and who have a valid driver license, a valid credit card, and a U.S. bank account. This online transaction may involve domains 191, 193, 195, and 197.

Typically, a user might not maintain an identity and/or attributes within each domain that participates in a typical online transaction. In this example, user 190 may have registered his or her identity with the user's ISP, but to complete the online transaction, the user might also be required to authenticate to domains 193, 195, and 197. If each of the domains does not maintain an identity for the user, then the user's online transaction may fail. Even if the user can be authenticated by each domain, it is not guaranteed that the different domains can transfer information between themselves in order to complete the user's transaction.

Given the preceding brief description of some current technology, the description of the remaining figures relates to federated computer environments in which the present invention may operate. Prior to discussing the present invention in more detail, however, some terminology is introduced.

Terminology

The terms “entity” or “party” generally refers to an organization, an individual, or a system that operates on behalf of an organization, an individual, or another system. The term “domain” connotes additional characteristics within a network environment, but the terms “entity”, “party”, and “domain” can be used interchangeably. For example, the term “domain” may also refer to a DNS (Domain Name System) domain, or more generally, to a data processing system that includes various devices and applications that appear as a logical unit to exterior entities.

The terms “request” and “response” should be understood to comprise data formatting that is appropriate for the transfer of information that is involved in a particular operation, such as messages, communication protocol information, or other associated information. A protected resource is a resource (an application, an object, a document, a page, a file, executable code, or other computational resource, communication-type resource, etc.) for which access is controlled or restricted.

A token provides direct evidence of a successful operation and is produced by the entity that performs the operation, e.g., an authentication token that is generated after a successful authentication operation. A Kerberos token is one example of an authentication token that may be used with the present invention. More information on Kerberos may be found in Kohl et al., “The Kerberos Network Authentication Service (V5)”, Internet Engineering Task Force (IETF) Request for Comments (RFC) 1510, 09/1993.

An assertion provides indirect evidence of some action. Assertions may provide indirect evidence of identity, authentication, attributes, authorization decisions, or other information and/or operations. An authentication assertion provides indirect evidence of authentication by an entity that is not the authentication service but that listened to the authentication service.

A Security Assertion Markup Language (SAML) assertion is an example of a possible assertion format that may be used with the present invention. SAML has been promulgated by the Organization for the Advancement of Structured Information Standards (OASIS), which is a non-profit, global consortium. SAML is described in “Assertions and Protocol for the OASIS Security Assertion Markup Language (SAML)”, Committee Specification 01, 05/31/2002, as follows:
The Security Assertion Markup Language (SAML) is an XML-based framework for exchanging security information. This security information is expressed in the form of assertions about subjects, where a subject is an entity (either human or computer) that has an identity in some security domain. A typical example of a subject is a person, identified by his or her email address in a particular Internet DNS domain. Assertions can convey information about authentication acts performed by subjects, attributes of subjects, and authorization decisions about whether subjects are allowed to access certain resources. Assertions are represented as XML constructs and have a nested structure, whereby a single assertion might contain several different internal statements about authentication, authorization, and attributes. Note that assertions containing authentication statements merely describe acts of authentication that happened previously. Assertions are issued by SAML authorities, namely, authentication authorities, attribute authorities, and policy decision points. SAML defines a protocol by which clients can request assertions from SAML authorities and get a response from them. This protocol, consisting of XML-based request and response message formats, can be bound to many different underlying communications and transport protocols; SAML currently defines one binding, to SOAP over HTTP. SAML authorities can use various sources of information, such as external policy stores and assertions that were received as input in requests, in creating their responses. Thus, while clients always consume assertions, SAML authorities can be both producers and consumers of assertions.
   The SAML specification states that an assertion is a package of information that supplies one or more statements made by an issuer. SAML allows issuers to make three different kinds of assertion statements: authentication, in which the specified subject was authenticated by a particular means at a particular time; authorization, in which a request to allow the specified subject to access the specified resource has been granted or denied; and attribute, in which the specified subject is associated with the supplied attributes. As discussed further below, various assertion formats can be translated to other assertion formats when necessary.

Authentication is the process of validating a set of credentials that are provided by a user or on behalf of a user. Authentication is accomplished by verifying something that a user knows, something that a user has, or something that the user is, i.e. some physical characteristic about the user. Something that a user knows may include a shared secret, such as a user's password, or by verifying something that is known only to a particular user, such as a user's cryptographic key. Something that a user has may include a smartcard or hardware token. Some physical characteristic about the user might include a biometric input, such as a fingerprint or a retinal map.

An authentication credential is a set of challenge/response information that is used in various authentication protocols. For example, a username and password combination is the most familiar form of authentication credentials. Other forms of authentication credential may include various forms of challenge/response information, Public Key Infrastructure (PKI) certificates, smartcards, biometrics, etc. An authentication credential is differentiated from an authentication assertion: an authentication credential is presented by a user as part of an authentication protocol sequence with an authentication server or service, and an authentication assertion is a statement about the successful presentation and validation of a user's authentication credentials, subsequently transferred between entities when necessary.

Federation Model for Computing Environment that May Incorporate the Present Invention

In the context of the World Wide Web, users are coming to expect the ability to jump from interacting with an application on one Internet domain to another application on another domain with minimal regard to the information barriers between each particular domain. Users do not want the frustration that is caused by having to authenticate to multiple domains for a single transaction. In other words, users expect that organizations should interoperate, but users generally want domains to respect their privacy. In addition, users may prefer to limit the domains that permanently store private information. These user expectations exist in a rapidly evolving heterogeneous environment in which many enterprises and organizations are promulgating competing authentication techniques.

The present invention is supported within a federation model that allows enterprises to provide a single-sign-on experience to a user. In other words, the present invention may be implemented within a federated, heterogeneous environment. As an example of a transaction that would benefit from a federated, heterogeneous environment, referring again to FIG. 1E, user 190 is able to authenticate to domain 191 and then have domain 191 provide the appropriate assertions to each downstream domain that might be involved in a transaction. These downstream domains need to be able to understand and trust authentication assertions and/or other types of assertions, even though there are no pre-established assertion formats between domain 191 and these other downstream domains. In addition to recognizing the assertions, the downstream domains need to be able to translate the identity contained within an assertion to an identity that represents user 190 within a particular domain, even though there is no pre-established identity mapping relationship. It should be noted, though, that the present invention is applicable to various types of domains and is not limited to ISP-type domains that are represented within FIG. 1E as exemplary domains.

The present invention is supported within a federated environment. In general, an enterprise has its own user registry and maintains relationships with its own set of users. Each enterprise typically has its own means of authenticating these users. However, the federated scheme for use with the present invention allows enterprises to cooperate in a collective manner such that users in one enterprise can leverage relationships with a set of enterprises through an enterprise's participation in a federation of enterprises. Users can be granted access to resources at any of the federated enterprises as if they had a direct relationship with each enterprise. Users are not required to register at each business of interest, and users are not constantly required to identify and authenticate themselves. Hence, within this federated environment, an authentication scheme allows for a single-sign-on experience within the rapidly evolving heterogeneous environments in information technology.

In the context of the present invention, a federation is a set of distinct entities, such as enterprises, organizations, institutions, etc., that cooperate to provide a single-sign-on, ease-of-use experience to a user; a federated environment differs from a typical single-sign-on environment in that two enterprises need not have a direct, pre-established, relationship defining how and what information to transfer about a user. Within a federated environment, entities provide services which deal with authenticating users, accepting authentication assertions, e.g., authentication tokens, that are presented by other entities, and providing some form of translation of the identity of the vouched-for user into one that is understood within the local entity.

Federation eases the administrative burden on service providers. A service provider can rely on its trust relationships with respect to the federation as a whole; the service provider does not need to manage authentication information, such as user password information, because it can rely on authentication that is accomplished by a user's authentication home domain or an identity provider.

The system that supports the present invention also concerns a federated identity management system that establishes a foundation in which loosely coupled authentication, user enrollment, user profile management and/or authorization services collaborate across security domains. Federated identity management allows services residing in disparate security domains to securely interoperate and collaborate even though there may be differences in the underlying security mechanisms and operating system platforms at these disparate domains.

Identity Provider vs. Service Provider

As mentioned above and as explained in more detail further below, a federated environment provides significant user benefits. A federated environment allows a user to authenticate at a first entity, which may act as an issuing party to issue an authentication assertion about the user for use at a second entity. The user can then access protected resources at a second, distinct entity, termed the relying party, by presenting the authentication assertion that was issued by the first entity without having to explicitly re-authenticate at the second entity. Information that is passed from an issuing party to a relying party is in the form of an assertion, and this assertion may contain different types of information in the form of statements. For example, an assertion may be a statement about the authenticated identity of a user, or it may be a statement about user attribute information that is associated with a particular user.

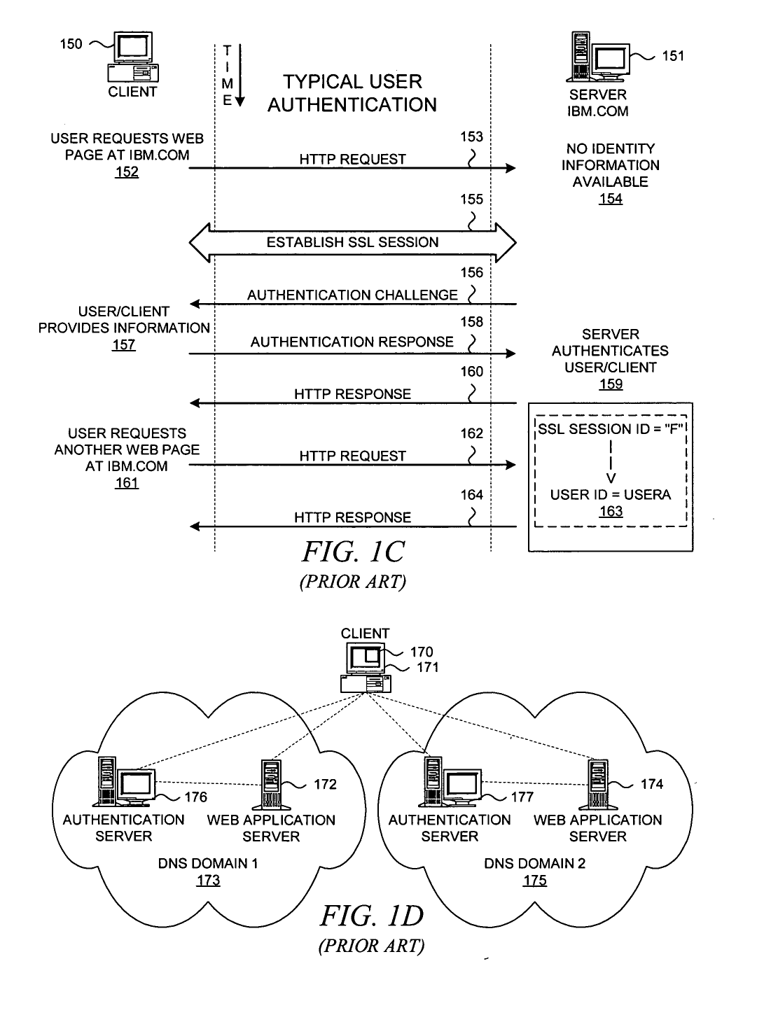

With reference now to FIG. 2, a block diagram depicts the terminology of the federated environment with respect to a transaction that is initiated by a user to a first federated enterprise, which, in response, invokes actions at downstream entities within the federated environment. FIG. 2 shows that the terminology may differ depending on the perspective of an entity within the federation for a given federated operation. More specifically, FIG. 2 illustrates that a computing environment that supports the present invention supports the transitivity of trust and the transitivity of the authentication assertion process; a domain or an entity can issue an assertion based on its trust in an identity as asserted by another domain or another entity.

User 202 initiates a transaction through a request for a protected resource at enterprise 204. If user 202 has been authenticated by enterprise 204 or will eventually be authenticated by enterprise 204 during the course of a transaction, then enterprise 204 may be termed the user's home domain for this federated session. Assuming that the transaction requires some type of operation by enterprise 206 and enterprise 204 transfers an assertion to enterprise 206, then enterprise 204 is the issuing entity with respect to the particular operation, and enterprise 206 is the relying entity for the operation.

The issuing entity issues an assertion for use by the relying domain; an issuing entity is usually, but not necessarily, the user's home domain or the user's identity provider. Hence, it would usually be the case that the issuing party has authenticated the user using a typical authentication operation. However, it is possible that the issuing party has previously acted as a relying party whereby it received an assertion from a different issuing party. In other words, since a user-initiated transaction may cascade through a series of enterprises within a federated environment, a receiving party may subsequently act as an issuing party for a downstream transaction. In general, any entity that has the ability to issue authentication assertions on behalf of a user can act as an issuing entity.

The relying entity is an entity that receives an assertion from an issuing entity. The relying party is able to accept, trust, and understand an assertion that is issued by a third party on behalf of the user, i.e. the issuing entity; it is generally the relying entity's duty to use an appropriate authentication authority to interpret an authentication assertion. A relying party is an entity that relies on an assertion that is presented on behalf of a user or another entity. In this manner, a user can be given a single-sign-on experience at the relying entity instead of requiring the relying entity to prompt the user for the user's authentication credentials as part of an interactive session with the user.

Referring again to FIG. 2, assuming that the transaction requires further operations such that enterprise 206 transfers an assertion to enterprise 208, then enterprise 206 is an upstream entity that acts as the issuing entity with respect to the subsequent or secondary transaction operation, and enterprise 208 is a downstream entity that acts as the relying entity for the operation; in this case, enterprise 208 may be regarded as another downstream entity with respect to the original transaction, although the subsequent transaction can also be described with respect to only two entities.

As shown in FIG. 2, a federated entity may act as a user's home domain, which provides identity information and attribute information about federated users. An entity within a federated computing environment that provides identity information, identity or authentication assertions, or identity services may be termed an identity provider. Other entities or federation partners within the same federation may rely on an identity provider for primary management of a user's authentication credentials, e.g., accepting a single-sign-on token that is provided by the user's identity provider; a domain at which the user authenticates may be termed the user's (authentication) home domain. The identity provider may be physically supported by the user's employer, the user's ISP, or some other commercial entity.

An identity provider is a specific type of service that provides identity information as a service to other entities within a federated computing environment. With respect to most federated transactions, an issuing party for an authentication assertion would usually be an identity provider; any other entity can be distinguished from the identity provider. Any other entity that provides a service within the federated computing environment can be categorized as a service provider. Once a user has authenticated to the identity provider, other entities or enterprises in the federation may be regarded as merely service providers for the duration of a given federated session or a given federated transaction.

In some circumstances, there may be multiple entities within a federated environment that may act as identity providers for a user. For example, the user may have accounts at multiple federated domains, each of which is able to act as an identity provider for the user; these domains do not necessarily have information about the other domains nor about a user's identity at a different domain.

Although it may be possible that there could be multiple enterprises within a federated environment that may act as identity providers, e.g., because there may be multiple enterprises that have the ability to generate and validate a user's authentication credentials, etc., a federated transaction usually involves only a single identity provider. If there is only a single federated entity that is able to authenticate a user, e.g., because there is one and only one entity within the federation with which the user has performed a federated enrollment or registration operation, then it would be expected that this entity would act as the user's identity provider in order to support the user's transactions throughout the federated environment.

Within some federated transactions that require the interoperation of multiple service providers, a downstream service provider may accept an assertion from an upstream service provider; the conditions in which an upstream service provider may act as an issuing entity to a downstream service provider that is acting as a relying party may depend upon the type of trust relationship between the service providers and the type of transaction between the service providers. Within the scope of a simple federated transaction, however, there is only one entity that acts as an issuing entity.

The present invention may be supported within a given computing environment in which a federated infrastructure can be added to existing systems while minimizing the impact on an existing, non-federated architecture. Hence, operations, including authentication operations, at any given enterprise or service provider are not necessarily altered by the fact that an entity may also participate within a federated environment. In other words, even though an entity's computing systems may be integrated into a federated environment, a user may be able to continue to perform various operations, including authentication operations, directly with an enterprise in a non-federated manner. However, the user may be able to have the same end-user experience while performing a federated operation with respect to a given entity as if the user had performed a similar operation with the given entity in a non-federated manner. Hence, it should be noted that not all of a given enterprise's users necessarily participate federated transactions when the given enterprise participates in a federation; some of the enterprise's users may interact with the enterprise's computing systems without performing any federated transactions.

Moreover, user registration within the computing environment of a given enterprise, e.g., establishment of a user account in a computer system, is not necessarily altered by the fact that the enterprise may also participate within a federated environment. For example, a user may still establish an account at a domain through a legacy or pre-existing registration process that is independent of a federated environment. Hence, in some cases, the establishment of a user account at an enterprise may or may not include the establishment of account information that is valid across a federation when the enterprise participates within a federated computing environment.

Federated Architecture—Federation Front-End for Legacy Systems

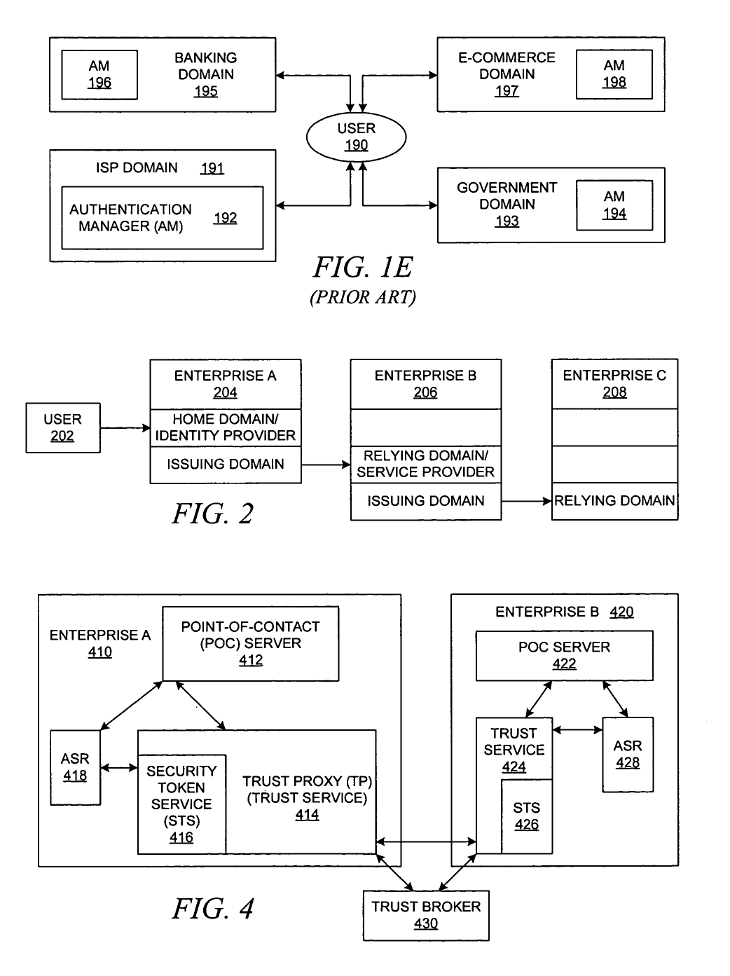

With reference now to FIG. 3, a block diagram depicts the integration of pre-existing data processing systems at a given domain with some federated architecture components that may be used to support an embodiment of the present invention. A federated environment includes federated entities that provide a variety of services for users. User 312 interacts with client device 314, which may support browser application 216 and various other client applications 318. User 312 is distinct from client device 314, browser 316, or any other software that acts as interface between user and other devices and services. In some cases, the following description may make a distinction between the user acting explicitly within a client application and a client application that is acting on behalf of the user. In general, though, a requester is an intermediary, such as a client-based application, browser, SOAP client, etc., that may be assumed to act on behalf of the user.

Browser application 316 may be a typical browser, including those found on mobile devices, that comprises many modules, such as HTTP communication component 320 and markup language (ML) interpreter 322. Browser application 316 may also support plug-ins, such as web services client 324, and/or downloadable applets, which may or may not require a virtual machine runtime environment. Web services client 324 may use Simple Object Access Protocol (SOAP), which is a lightweight protocol for defining the exchange of structured and typed information in a decentralized, distributed environment. SOAP is an XML-based protocol that consists of three parts: an envelope that defines a framework for describing what is in a message and how to process it; a set of encoding rules for expressing instances of application-defined datatypes; and a convention for representing remote procedure calls and responses. User 312 may access web-based services using browser application 316, but user 312 may also access web services through other web service clients on client device 314. Some of the federated operations may employ HTTP redirection via the user's browser to exchange information between entities in a federated environment. However, it should be noted that the present invention may be supported over a variety of communication protocols and is not meant to be limited to HTTP-based communications. For example, the entities in the federated environment may communicate directly when necessary; messages are not required to be redirected through the user's browser.

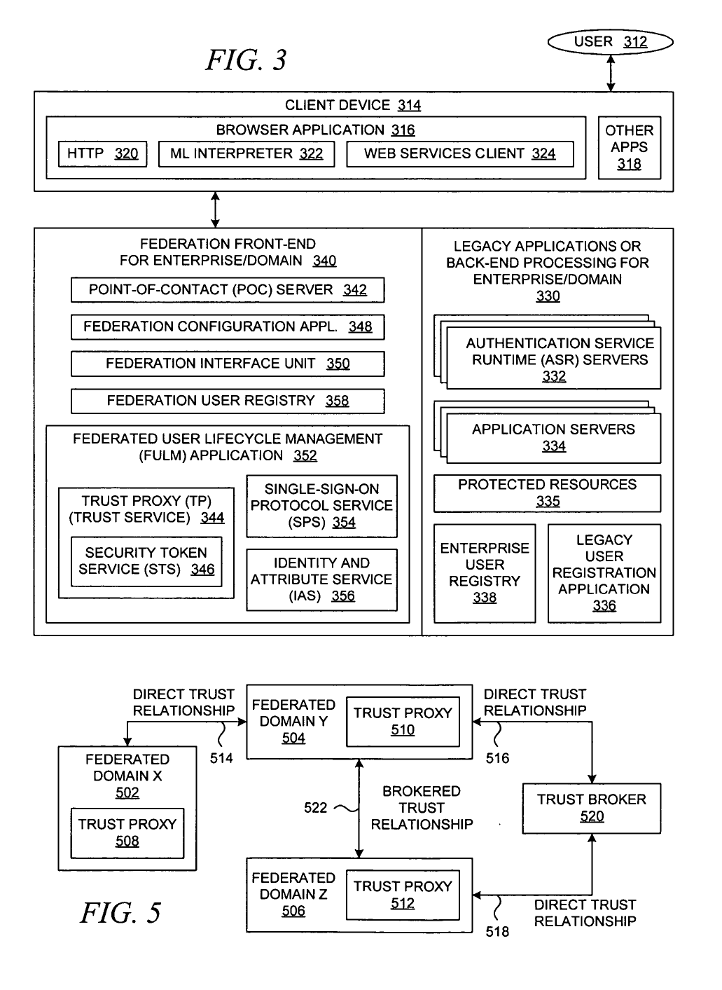

The present invention may be supported in a manner such that components that are required for a federated environment can be integrated with pre-existing systems. FIG. 3 depicts one embodiment for implementing these components as a front-end to a pre-existing system. The pre-existing components at a federated domain can be considered as legacy applications or back-end processing components 330, which include authentication service runtime (ASR) servers 332 in a manner similar to that shown in FIG. 4. ASR servers 332 are responsible for authenticating users when the domain controls access to application servers 334, which can be considered to generate, retrieve, or otherwise support or process protected resources 335. The domain may continue to use legacy user registration application 336 to register users for access to application servers 334. Information that is needed to authenticate a registered user with respect to legacy operations is stored in enterprise user registry 338; enterprise user registry 338 may be accessible to federation components as well.

After joining a federated environment, the domain may continue to operate without the intervention of federated components. In other words, the domain may be configured so that users may continue to access particular application servers or other protected resources directly without going through a point-of-contact server or other component implementing this point-of-contact server functionality; a user that accesses a system in this manner would experience typical authentication flows and typical access. In doing so, however, a user that directly accesses the legacy system would not be able to establish a federated session that is known to the domain's point-of-contact server.

The domain's legacy functionality can be integrated into a federated environment through the use of federation front-end processing 340, which includes point-of-contact server 342 and trust proxy server 344 (or more simply, trust proxy 344 or trust service 344) which itself interacts with Security Token Service (STS) 346, which are described in more detail below with respect to FIG. 4. Federation configuration application 348 allows an administrative user to configure the federation front-end components to allow them to interface with the legacy back-end components through federation interface unit 350. Federated functionality may be implemented in distinct system components or modules. In a preferred embodiment, most of the functionality for performing federation operations may be implemented by a collection of logical components within a single federation application; federated user lifecycle management application 352 includes trust service 344 along with single-sign-on protocol service (SPS) 354. Trust service 344 may comprise identity-and-attribute service (IAS) 356, which is responsible for identity mapping operations, attribute retrieval, etc., as part of federation functionality. Identity-and-attribute service 356 may also be employed by single-sign-on protocol service 354 during single-sign-on operations. A federation user registry 358 may be employed in certain circumstances to maintain user-related information for federation-specific purposes.

Legacy or pre-existing authentication services at a given enterprise may use various, well known, authentication methods or tokens, such as username/password or smart card token-based information. However, in a preferred federated computing system for supporting the present invention, the functionality of a legacy authentication service can be used in a federated environment through the use of point-of-contact servers. Users may continue to access a legacy authentication server directly without going through a point-of-contact server, although a user that accesses a system in this manner would experience typical authentication flows and typical access; a user that directly accesses a legacy authentication system would not be able to generate a federated authentication assertion as proof of identity in accordance with the present invention. One of the roles of the federation front-end is to translate a federated authentication token received at a point-of-contact server into a format understood by a legacy authentication service. Hence, a user accessing the federated environment via the point-of-contact server would not necessarily be required to re-authenticate to the legacy authentication service. Preferably, the user would be authenticated to a legacy authentication service by a combination of the point-of-contact server and a trust proxy such that it appears as if the user was engaged in an authentication dialog.

Federated Architecture—Point-of-Contact Servers, Trust Proxies, and Trust Brokers

With reference now to FIG. 4, a block diagram depicts an example of a manner in which some components within a federated architecture may be used to establish trust relationships to support an implementation of the present invention. A federated environment includes federated enterprises or similar entities that provide a variety of services for users. A user, through an application on a client device, may attempt to access resources at various entities, such as enterprise 410. A point-of-contact server at each federated enterprise, such as point-of-contact (POC) server 412 at enterprise 410, is the entry point into the federated environment for requests from a client to access resources that are supported and made available by enterprise 410. The point-of-contact server minimizes the impact on existing components within an existing, non-federated architecture, e.g., legacy systems, because the point-of-contact server handles many of the federation requirements. The point-of-contact server provides session management, protocol conversion, and possibly initiates authentication and/or attribute assertion conversion. For example, the point-of-contact server may translate HTTP or HTTPS messages to SOAP and vice versa. As explained in more detail further below, the point-of-contact server may also be used to invoke a trust proxy to translate assertions, e.g., a SAML token received from an issuing party can be translated into a Kerberos token understood by a receiving party.

A trust service (also termed a trust proxy, a trust proxy server, or a trust service), such as trust proxy (TP) 414 at enterprise 410, establishes and maintains a trust relationship between two entities in a federation. A trust service generally has the ability to handle authentication token format translation (through the security token service, which is described in more detail further below) from a format used by the issuing party to one understood by the receiving party.

Together, the use of a point-of-contact server and a trust service minimize the impact of implementing a federated architecture on an existing, non-federated set of systems. Hence, the exemplary federated architecture requires the implementation of at least one point-of-contact server and at least one trust service per federated entity, whether the entity is an enterprise, a domain, or other logical or physical entity. The exemplary federated architecture, though, does not necessarily require any changes to the existing, non-federated set of systems. Preferably, there is a single trust service for a given federated entity, although there may be multiple instances of a trust service component for availability purposes, or there may be multiple trust services for a variety of smaller entities within a federated entity, e.g., separate subsidiaries within an enterprise. It is possible that a given entity could belong to more than one federation, although this scenario would not necessarily require multiple trust services as a single trust service may be able to manage trust relationships within multiple federations.

One role of a trust service may be to determine or to be responsible for determining the required token type by another domain and/or the trust service in that domain. A trust service has the ability or the responsibility to handle authentication token format translation from a format used by the issuing party to one understood by the receiving party. Trust service 414 may also be responsible for any user identity translation or attribute translation that occurs for enterprise 410, or this responsibility may be supported by a distinct identity-and-attribute service, e.g., such as identity-and-attribute service 356 as shown in FIG. 3. In addition, a trust service can support the implementation of aliases as representatives of a user identity that uniquely identify a user without providing any addition information about the user's real world identity. Furthermore, a trust proxy can issue authorization and/or session credentials for use by the point-of-contact server. However, a trust service may invoke a trust broker for assistance, as described further below. Identity translation may be required to map a user's identity and attributes as known to an issuing party to one that is meaningful to a receiving party. This translation may be invoked by either a trust service at an issuing entity, a trust service at a receiving entity, or both.

Trust service 414, or a distinct identity-and-attribute service as mentioned above, may include (or interact with) an internalized component, shown as security token service (STS) component 416, which will provide token translation and will invoke authentication service runtime (ASR) 418 to validate and generate tokens. The security token service provides the token issuance and validation services required by the trust service, which may include identity translation. The security token service therefore includes an interface to existing authentication service runtimes, or it incorporates authentication service runtimes into the service itself. Rather than being internalized within the trust service, the security token service component may also be implemented as a stand-alone component, e.g., to be invoked by the trust service, or it may be internalized within a transaction server, e.g., as part of an application server.

For example, an security token service component may receive a request to issue a Kerberos token. As part of the authentication information of the user for whom the token is to be created, the request may contain a binary token containing a username and password. The security token service component will validate the username and password against, e.g., an LDAP runtime (typical authentication) and will invoke a Kerberos KDC (Key Distribution Center) to generate a Kerberos ticket for this user. This token is returned to the trust service for use within the enterprise; however, this use may include externalizing the token for transfer to another domain in the federation.

In a manner similar to that described with respect to FIG. 1D, a user may desire to access resources at multiple enterprises within a federated environment, such as both enterprise 410 and enterprise 420. In a manner similar to that described above for enterprise 410, enterprise 420 comprises point-of-contact server 422, trust service 424, security token service (STS) 426, and authentication service runtime 428. Although the user may directly initiate separate transactions with each enterprise, the user may initiate a transaction with enterprise 410 which cascades throughout the federated environment. Enterprise 410 may require collaboration with multiple other enterprises within the federated environment, such as enterprise 420, to complete a particular transaction, even though the user may not have been aware of this necessity when the user initiated a transaction. Enterprise 420 becomes involved as a downstream entity, and enterprise 410 may present a assertion to enterprise 420 if necessary in order to further the user's federated transaction.

It may be the case that a trust service does not know how to interpret the authentication token that is received by an associated point-of-contact server and/or how to translate a given user identity and attributes. In this case, the trust service may choose to invoke functionality at a trust broker component, such as trust broker 430. A trust broker maintains relationships with individual trust proxies/services, thereby providing transitive trust between trust services. Using a trust broker allows each entity within a federated environment, such enterprises 410 and 420, to establish a trust relationship with the trust broker rather than establishing multiple individual trust relationships with each entity in the federated environment. For example, when enterprise 420 becomes involved as a downstream entity for a transaction initiated by a user at enterprise 410, trust service 414 at enterprise 410 can be assured that trust service 424 at enterprise 420 can understand an assertion from trust service 414 by invoking assistance at trust broker 430 if necessary. Although FIG. 4 depicts the federated environment with a single trust broker, a federated environment may have multiple trust brokers.

It should be noted that although FIG. 4 depicts point-of-contact server 412, trust service 414, security token service component 416, and authentication service runtime 418 as distinct entities, it is not necessary for these components to be implemented on separate components. For example, it is possible for the functionality of these separate components to be implemented as a single application, as applications on a single physical device, or as distributed applications on multiple physical devices. In addition, FIG. 4 depicts a single point-of-contact server, a single trust service, and a single security token server for an enterprise, but an alternative configuration may include multiple point-of-contact servers, multiple trust services, and multiple security token servers for each enterprise. The point-of-contact server, the trust service, the security token service, and other federated entities may be implemented in various forms, such as software applications, objects, modules, software libraries, etc.

A trust service/STS may be capable of accepting and validating many different authentication credentials, including traditional credentials such as a username and password combinations and Kerberos tickets, and federated authentication token formats, including authentication tokens produced by a third party. A trust service/STS may allow the acceptance of an authentication token as proof of authentication elsewhere. The authentication token is produced by an issuing party and is used to indicate that a user has already authenticated to that issuing party. The issuing party produces the authentication token as a means of asserting the authenticated identity of a user. A trust service/STS is also able to process attribute tokens or tokens that are used to secure communication sessions or conversations, e.g., those that are used to manage session information in a manner similar to an SSL session identifier.

A security token service invokes an authentication service runtime as necessary. The authentication service runtime supports an authentication service capable of authenticating a user. The authentication service acts as an authentication authority that provides indications of successful or failed authentication attempts via authentication responses. The trust service/STS may internalize an authentication service, e.g., a scenario in which there is a brand-new installation of a web service that does not need to interact with an existing legacy infrastructure. Otherwise, the security token service component will invoke external authentication services for validation of authentication tokens. For example, the security token service component could “unpack” a binary token containing a username/password and then use an LDAP service to access a user registry to validate the presented credentials.

When used by another component such as an application server, the security token service component can be used to produce tokens required for single-sign-on to legacy authentication systems; this functionality may be combined with or replaced by functionality within a single-sign-on protocol service, such as SPS 354 that is shown in FIG. 3. Hence, the security token service component can be used for token translation for internal purposes, i.e. within an enterprise, and for external purposes, i.e. across enterprises in a federation. As an example of an internal purpose, a Web application server may interface to a mainframe via an IBM CICS (Customer Information Control System) transaction gateway; CICS is a family of application servers and connectors that provides enterprise-level online transaction management and connectivity for mission-critical applications. The Web application server may invoke the security token service component to translate a Kerberos ticket (as used internally by the Web application server) to an IBM RACF® passticket required by the CICS transaction gateway.

The entities that are shown in FIG. 4 can be explained using the terminology that was introduced above, e.g., “identity provider” and “service provider”. As part of establishing and maintaining trust relationships, an identity provider's trust service can determine what token types are required/accepted by a service provider's trust service. Thus, trust services use this information when invoking token services from a security token service. When an identity provider's trust service is required to produce an authentication assertion for a service provider, the trust service determines the required token type and requests the appropriate token from the security token service.

When a service provider's trust service receives an authentication assertion from an identity provider, the trust service knows what type of assertion that it expected and what type of assertion that it needs for internal use within the service provider. The service provider's trust service therefore requests that the security token service generate the required internal-use token based on the token in the received authentication assertion.

Both trust services and trust brokers have the ability to translate an assertion received from an identity provider into a format that is understood by a service provider. The trust broker has the ability to interpret the assertion format (or formats) for each of the trust services with whom there is a direct trust relationship, thereby allowing the trust broker to provide assertion translation between an identity provider and a service provider. This translation can be requested by either party through its local trust service. Thus, the identity provider's trust service can request translation of an assertion before it is sent to the service provider. Likewise, the service provider's trust service can request translation of an assertion received from an identity provider.

Assertion translation comprises user identity translation, authentication assertion translation, attribute assertion translation, or other forms of assertion translation. Reiterating the point above, assertion translation is handled by the trust components within a federation, e.g., trust services and trust brokers. A trust service may perform the translation locally, either at the identity provider or at the service provider, or a trust service may invoke assistance from a trust broker.

Assuming that an identity provider and a service provider already have individual trust relationships with a trust broker, the trust broker can dynamically create, i.e. broker, new trust relationships between issuing parties and relying parties if necessary. After the initial trust relationship brokering operation that is provided by the trust broker, the identity provider and the service provider may directly maintain the relationship so that the trust broker need not be invoked for future translation requirements. It should be noted that translation of authentication tokens can happen at three possible places: the identity provider's trust service, the service provider's trust service, and the trust broker. Preferably, the identity provider's trust service generates an authentication assertion that is understood by the trust broker to send to the service provider. The service provider then requests a translation of this token from the trust broker into a format recognizable by the service provider. Token translation may occur before transmission, after transmission, or both before and after transmission of the authentication assertion.

Trust Relationships Within Federated Architecture

Within an exemplary federated environment that is able to support the present invention, there are two types of “trust domains” that must be managed: enterprise trust domains and federation trust domains. The differences between these two types of trust domain are based in part on the business agreements governing the trust relationships with the trust domain and the technology used to establish trust. An enterprise trust domain contains those components that are managed by the enterprise; all components within that trust domain may implicitly trust each other. In general, there are no business agreements required to establish trust within an enterprise because the deployed technology creates inherent trust within an enterprise, e.g., by requiring mutually authenticated SSL sessions between components or by placing components within a single, tightly controlled data center such that physical control and proximity demonstrate implicit trust. Referring to FIG. 2B, the legacy applications and back-end processing systems may represent an enterprise trust domain, wherein the components communicate on a secure internal network.

Federation trust domains are those that cross enterprise boundaries; from one perspective, a federation trust domain may represent trust relationships between distinct enterprise trust domains. Federation trust domains are established through trust proxies across enterprise boundaries between federation partners. Trust relationships involve some sort of a bootstrapping process by which initial trust is established between trust proxies. Part of this bootstrap process may include the establishment of shared secret keys and rules that define the expected and/or allowed token types and identifier translations. In general, this bootstrapping process can be implemented out-of-band as this process may also include the establishment of business agreements that govern an enterprise's participation in a federation and the liabilities associated with this participation.

There are a number of possible mechanisms for establishing trust in a federated business model. In a federation model, a fundamental notion of trust between the federation participants is required for business reasons in order to provide a level of assurance that the assertions (including tokens and attribute information) that are transferred between the participants are valid. If there is no trust relationship, then the service provider cannot depend upon the assertions received from the identity provider; they cannot be used by the service provider to determine how to interpret any information received from the identity provider.

For example, a large corporation may want to link several thousand global customers, and the corporation could use non-federated solutions. As a first example, the corporation could require global customers to use a digital certificate from a commercial certificate authority to establish mutual trust. The commercial certificate authority enables the servers at the corporation to trust servers located at each of the global customers. As a second example, the corporation could implement third-party trust using Kerberos; the corporation and its global customers could implement a trusted third-party Kerberos domain service that implements shared-secret-based trust. As a third example, the corporation could establish a private scheme with a proprietary security message token that is mutually trusted by the servers of its global customers.

Any one of these approaches may be acceptable if the corporation needed to manage trust relationships with a small number of global customers, but this may become unmanageable if there are hundreds or thousands of potential federation partners. For example, while it may be possible for the corporation to force its smaller partners to implement a private scheme, it is unlikely that the corporation will be able to impose many requirements on its larger partners.

An enterprise may employ trust relationships established and maintained through trust proxies and possibly trust brokers. An advantage of the exemplary federated architecture that is shown in the figures is that it does not impose additional requirements above and beyond the current infrastructures of an enterprise and its potential federation partners.

However, this exemplary federation architecture does not relieve an enterprise and its potential federation partners from the preliminary work required to establish business and liability agreements that are required for participation in the federation. In addition, the participants cannot ignore the technological bootstrapping of a trust relationship. The exemplary federation architecture allows this bootstrapping to be flexible, e.g., a first federation partner can issue a Kerberos ticket with certain information, while a second federation partner can issue a SAML authentication assertion with certain information.

In the exemplary federation architecture, the trust relationships are managed by the trust proxies, which may include (or may interact with) a security token service that validates and translates a token that is received from an identity provider based on the pre-established relationship between two trust proxies. In situations where it is not feasible for a federated enterprise to establish trust relationships (and token translation) with another federated enterprise, a trust broker may be invoked; however, the federated enterprise would need to establish a relationship with a trust broker.

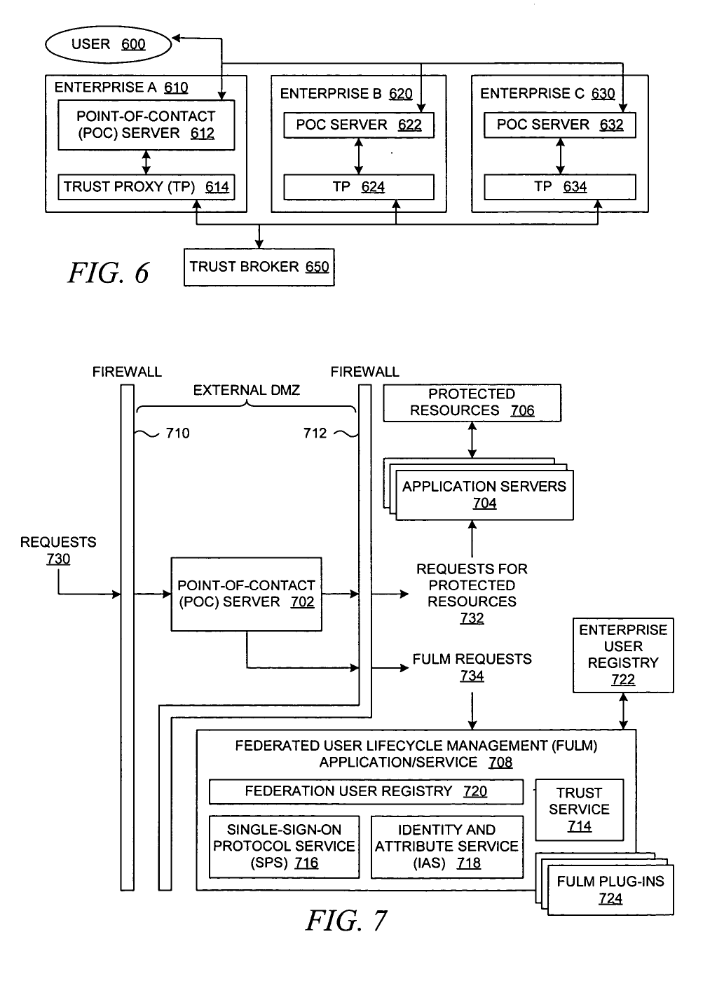

With reference now to FIG. 5, a block diagram depicts an exemplary set of trust relationships between federated domains using trust proxies and a trust broker in accordance with an exemplary federated architecture that is able to support the present invention. Although FIG. 4 introduced the trust broker, FIG. 5 illustrates the importance of transitive trust relationships within the exemplary federated architecture.

Federated domains 502-506 incorporate trust proxies 508-512, respectively. Trust proxy 508 has direct trust relationship 514 with trust proxy 510. Trust broker 520 has direct trust relationship 516 with trust proxy 510, and trust broker 520 has direct trust relationship 518 with trust proxy 512. Trust broker 520 is used to establish, on behalf of a federation participant, a trust relationship based on transitive trust with other federation partners. The principle of transitive trust allows trust proxy 510 and trust proxy 512 to have brokered trust relationship 522 via trust broker 520. Neither trust proxy 510 nor 512 need to know how to translate or validate the other's assertions; the trust broker may be invoked to translate an assertion into one that is valid, trusted, and understood at the other trust proxy.

Business agreements that specify contractual obligations and liabilities with respect to the trust relationships between federated enterprises can be expressed in XML through the use of the ebXML (Electronic Business using XML) standards. For example, a direct trust relationship could be represented in an ebXML document; each federated domain that shares a direct trust relationship would have a copy of a contract that is expressed as an ebXML document. Operational characteristics for various entities within a federation may be specified within ebXML choreographies and published within ebXML registries; any enterprise that wishes to participate in a particular federation, e.g., to operate a trust proxy or trust broker, would need to conform to the published requirements that were specified by that particular federation for all trust proxies or trust brokers within the federation. A security token service could parse these ebXML documents for operational details on the manner in which tokens from other domains are to be translated. It should be noted, though, that other standards and mechanisms could be employed to support the present invention for specifying the details about the manner in which the trust relationships within a federation are implemented.

Single-Sign-On Within Federated Architecture

During a given user's session, the user may visit many federated domains to use the web services that are offered by those domains. Domains can publish descriptions of services that they provide using standard specifications such as UDDI and WSDL, both of which use XML as a common data format. The user finds the available services and service providers through applications that also adhere to these standard specifications. SOAP provides a paradigm for communicating requests and responses that are expressed in XML. Entities within a federated environment may employ these standards among others.

Within a federation, a user expects to have a single-sign-on experience in which the user completes a single authentication operation, and this authentication operation suffices for the duration of the user's session, regardless of the federation partners visited during that session. A session can be defined as the set of transactions from (and including) the initial user authentication, i.e. logon, to logout. Within a session, a user's actions will be governed in part by the privileges granted to the user for that session.

The federated architecture that is described hereinabove supports single-sign-on operations. To facilitate a single-sign-on experience, web services that support the federated environment will also support using an authentication assertion or security token generated by a third-party to provide proof of authentication of a user. This assertion will contain some sort of evidence of the user's successful authentication to the issuing party together with an identifier for that user. For example, a user may complete traditional authentication operation with one federation partner, e.g., by providing a username and password that the federation partners uses to build authentication credentials for the user, and then the federation partner is able to provide a SAML authentication assertion that is generated by the authenticating/issuing party to a different federation partner.

The federated environment also allows web services or other applications to request web services, and these web services would also be authenticated. Authentication in a web services environment is the act of verifying the claimed identity of the web services request so that the enterprise can restrict access to authorized clients. A user who requests or invokes a web service would almost always authenticated, so the need for authentication within a federated environment that supports the present invention is not any different from current requirements of web services for user authentication.

Authentication of users that are accessing the computational resources of an enterprise without participating in a federated session are not impacted by the presence of a federated infrastructure. For example, an existing user who authenticates with a forms-based authentication mechanism over HTTP/S to access non-federated resources at a particular domain is not affected by the introduction of support at the domain for the federated environment. Authentication is handled in part by a point-of-contact server, which in turn may invoke a separate trust proxy or trust service component; the use of a point-of-contact server minimizes the impact on the infrastructure of an existing domain. For example, the point-of-contact server can be configured to pass through all non-federated requests to be handled by the back-end or legacy applications and systems at the domain.

The point-of-contact server may choose to invoke an HTTP-based authentication method, such as basic authentication, forms-based authentication, or some other authentication method. The point-of-contact server also supports a federation domain by recognizing an assertion that has been presented by the user as proof of authentication, such as an SAML authentication assertion, wherein the assertion has crossed between enterprise domains. The point-of-contact server may invoke the trust service, which in turn may invoke its security token service for validation of authentication credentials/security tokens.

Authentication of web services or other applications comprises the same process as authentication of users. Requests from web services carry a security token containing an authentication assertion, and this security token would be validated by the trust service in the same manner as a token presented by a user. A request from a web service should be accompanied by this token because the web service would have discovered what authentication assertions/security tokens were required by the requested service as advertised in UDDI.

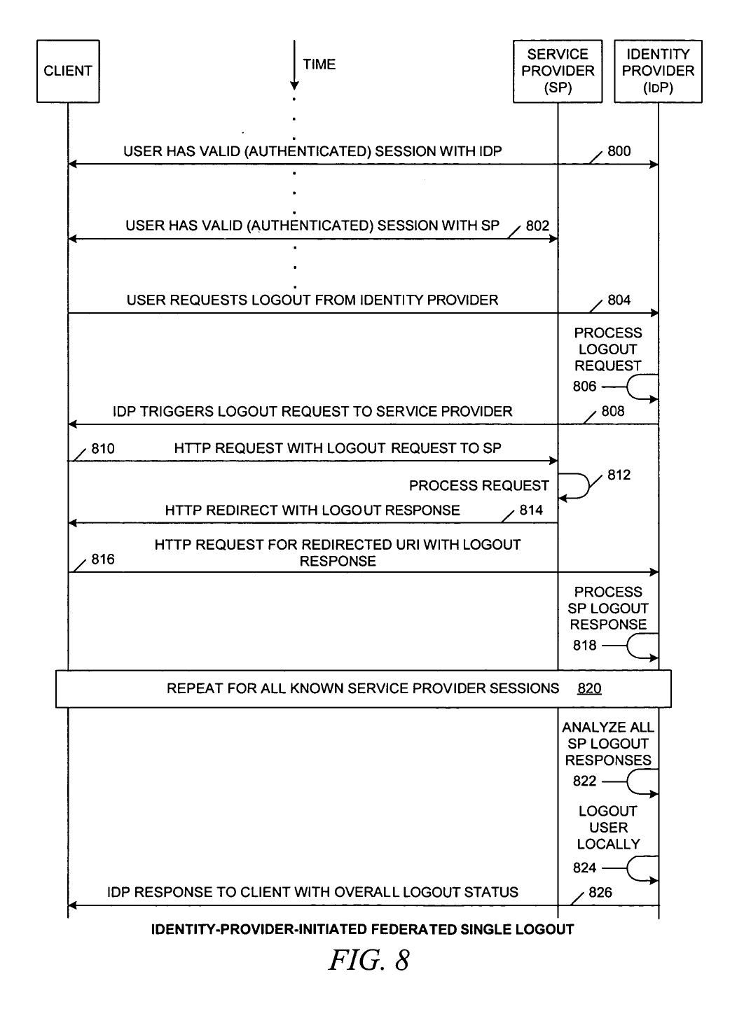

With reference now to FIG. 6, a block diagram depicts a federated environment that supports federated single-sign-on operations. User 600, through a client device and an appropriate client application, such as a browser, desires to access a web service that is provided by enterprise/domain 610, which supports data processing systems that act as a federated domain within a federated environment. Domain 610 supports point-of-contact server 612 and trust proxy or trust service 614; similarly, domain 620 supports point-of-contact server 622 and trust proxy or trust service 624, while domain 630 supports point-of-contact server 632 and trust proxy or trust service 634. The trust proxies/services rely upon trust broker 650 for assistance, as described above. Additional domains and trust proxies/services may participate in the federated environment. FIG. 6 is used to describe a federated single-sign-on operation between domain 610 and domain 620; a similar operation may occur between domain 610 and domain 630.

The user completes an authentication operation with respect to domain 610; this authentication operation is handled by point-of-contact server 612. The authentication operation is triggered when the user requests access to some resource that requires an authenticated identity, e.g., for access control purposes or for personalization purposes. Point-of-contact server 612 may invoke a legacy authentication service, or it may invoke trust proxy 614 to validate the user's presented authentication credentials. Domain 610 becomes the user's identity provider or home domain for the duration of the user's federated session.

At some later point in time, the user initiates a transaction at a federation partner, such as enterprise 620 that also supports a federated domain, thereby triggering a federated single-sign-on operation. For example, a user may initiate a new transaction at domain 620, or the user's original transaction may cascade into one or more additional transactions at other domains. As another example, the user may invoke a federated single-sign-on operation to a resource in domain 620 via point-of-contact server 612, e.g., by selecting a special link on a web page that is hosted within domain 610 or by requesting a portal page that is hosted within domain 610 but that displays resources hosted in domain 620. Point-of-contact server 612 sends a request to trust proxy 614 to generated a federation single-sign-on token for the user that is formatted to be understood or trusted by domain 620. Trust proxy 614 returns this token to point-of-contact server 612, which sends this token to point-of-contact server 622 in domain. Domain 610 acts as an issuing party for the user at domain 620, which acts as a relying party. The user's token would be transferred with the user's request to domain 620; this token may be sent using HTTP redirection via the user's browser, or it may be sent by invoking the request directly of point-of-contact server 622 (over HTTP or SOAP-over-HTTP) on behalf of the user identified in the token supplied by trust proxy 614.

Point-of-contact server 622 receives the request together with the federation single-sign-on token and invokes trust proxy 624. Trust proxy 624 receives the federation single-sign-on token, validates the token, and assuming that the token is valid and trusted, generates a locally valid token for the user. Trust proxy 624 returns the locally valid token to point-of-contact server 622, which establishes a session for the user within domain 620. If necessary, point-of-contact server 622 can initiate a federated single-sign-on at another federated partner.

Validation of the token at domain 620 is handled by the trust proxy 624, possibly with assistance from a security token service. Depending on the type of token presented by domain 610, the security token service may need to access a user registry at domain 620. For example, domain 620 may provide a binary security token containing the user's name and password to be validated against the user registry at domain 620. Hence, in this example, an enterprise simply validates the security token from a federated partner. The trust relationship between domains 610 and 620 ensures that domain 620 can understand and trust the security token presented by domain 610 on behalf of the user.

Federated single-sign-on requires not only the validation of the security token that is presented to a relying domain on behalf of the user but the determination of a locally valid user identifier at the relying domain based on information contained in the security token. One result of a direct trust relationship and the business agreements required to establish such a relationship is that at least one party, either the issuing domain or the relying domain or both, will know how to translate the information provided by the issuing domain into an identifier valid at the relying domain. In the brief example above, it was assumed that the issuing domain, i.e. domain 610, is able to provide the relying domain, i.e. domain 620, with a user identifier that is valid in domain 620. In that scenario, the relying domain did not need to invoke any identity mapping functionality. Trust proxy 624 at domain 620 will generate a security token for the user that will “vouch-for” this user. The types of tokens that are accepted, the signatures that are required on tokens, and other requirements are all pre-established as part of the federation's business agreements. The rules and algorithms that govern identifier translation are also pre-established as part of the federation's business agreements. In the case of a direct trust relationship between two participants, the identifier translation algorithms will have been established for those two parties and may not be relevant for any other parties in the federation.

However, it is not always the case that the issuing domain will know how to map the user from a local identifier for domain 610 to a local identifier for domain 620. In some cases, it may be the relying domain that knows how to do this mapping, while in yet other cases, neither party will know how to do this translation, in which case a third party trust broker may need to be invoked. In other words, in the case of a brokered trust relationship, the issuing and relying domains do not have a direct trust relationship with each other. They will, however, have a direct trust relationship with a trust broker, such as trust broker 650. Identifier mapping rules and algorithms will have been established as part of this relationship, and the trust broker will use this information to assist in the identifier translation that is required for a brokered trust relationship.

Domain 620 receives the token that is issued by domain 610 at point-of-contract server 622, which invokes trust proxy 624 to validate the token and perform identity mapping. In this case, since trust proxy 624 is not able to map the user from a local identifier for domain 610 to a local identifier for domain 620, trust proxy 624 invokes trust broker 650, which validates the token and performs the identifier mapping. After obtaining the local identifier for the user, trust proxy 624, possibly through its security token service, can generate any local tokens that are required by the back-end applications at domain 620, e.g., a Kerberos token may be required to facilitate single-sign-on from the point-of-contact server to the application server. After obtaining a locally valid token, if required, the point-of-contact server is able to build a local session for the user. The point-of-contract server will also handle coarse-grained authorization of user requests and forward the authorized requests to the appropriate application servers within domain 620.

Federated User Lifecycle Management

A portion of the above description of FIGS. 2-6 explained an organization of components that may be used in a federated environment while other portions explained the processes for supporting single-sign-on operations across the federated environment. Service providers or relying domains within a federated environment do not necessarily have to manage a user's authentication credentials, and those relying domains can leverage a single single-sign-on token that is provided by the user's identity provider or home domain. The description of FIGS. 2-6 above, though, does not explain an explicit process by which federated user lifecycle management may be accomplished in an advantageous manner at the federated domains of federation partners.

Federated user lifecycle management functionality/service comprises functions for supporting or managing federated operations with respect to the particular user accounts or user profiles of a given user at multiple federated domains; in some cases, the functions or operations are limited to a given federated session for the user. In other words, federated user lifecycle management functionality refers to the functions that allow management of federated operations across a plurality of federated partners, possibly only during the lifecycle of a single user session within a federated computing environment.

Each federated domain might manage a user account, a user profile, or a user session of some kind with respect to the functions at each respective federated domain. For example, a particular federated domain might not manage a local user account or user profile within the particular federated domain, but the federated domain might manage a local user session for a federated transaction after the successful completion of a single-sign-on operation at the federated domain. As part of the federated user lifecycle management functionality that is supported by that particular federated domain, the federated domain can participate in a single-sign-off operation that allows the federated domain to terminate the local user session after the federated transaction is complete, thereby improving security and promoting efficient use of resources.

In another example of the use of federated user lifecycle management functionality, a user may engage in an online transaction that requires the participation of multiple federated domains. A federated domain might locally manage a user profile in order to tailor the user's experience with respect to the federated domain during each of the user's federated sessions that involve the federated domain. As part of the federated user lifecycle management functionality that is supported by that particular federated domain, the information in the federated domain's local user profile can be used in a seamless manner during a given federated transaction with information from other profiles at other federated domains that are participating in the given federated transaction. For example, the information from the user's multiple local user profiles might be combined in some type of merging operation such that the user's information is visually presented to the user, e.g., within a web page, in a manner such that the user is not aware of the different origins or sources of the user's information.

Federated user lifecycle management functionality may also comprise functions for account linking/delinking. A user is provided with a common unique user identifier across federation partners, which enables single-sign-on and the retrieval of attributes (if necessary) about a user as part of the fulfillment of a request at one federation partner. Furthermore, the federation partner can request additional attributes from an identity provider using the common unique user identifier to refer to the user in an anonymous manner.

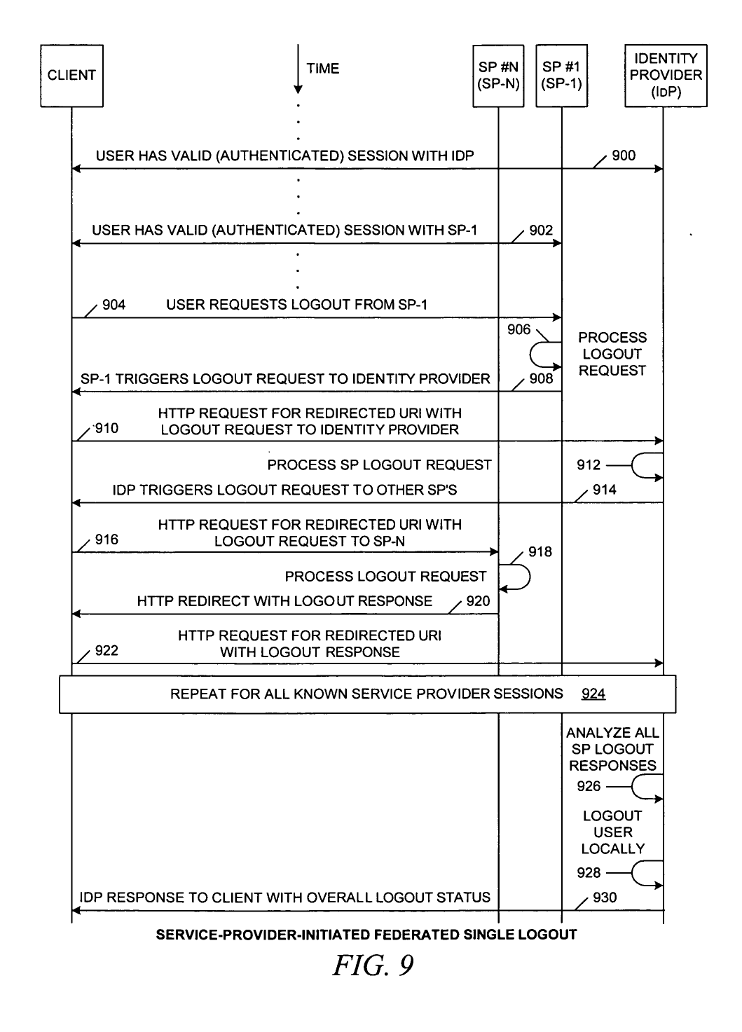

With reference now to FIG. 7, a block diagram depicts some of the components in a federated domain for implementing federated user lifecycle management functionality in order to support the present invention. FIG. 7 depicts elements at a single federated domain, such as the federated domain that is shown in FIG. 3. Some of the elements in FIG. 7 are similar or identical to elements that have been discussed hereinabove with respect to other figures, such as FIG. 3: point-of-contact server/service 702 is equivalent to point-of-contact server 342; application servers 704, which run services that control access to protected resources, are equivalent to application servers 334; protected or controlled resources 706 are equivalent to protected resources 335; and federated user lifecycle management (FULM) application 708 is equivalent to federated user lifecycle management application 352. Although firewalls were not illustrated within FIG. 3, firewalls are illustrated within FIG. 7. Firewall 710 and firewall 712 create an external DMZ (electronic DeMilitarized Zone) that protects the enterprise's computing environment from computing threats outside of the enterprise's domain, e.g., via the Internet.

The different perspectives that are shown in FIG. 3 and FIG. 7 are not incompatible or at cross-purposes. In contrast with the example that is shown in FIG. 7,-FIG. 3 does not illustrate the firewalls, yet point-of-contact server 342 resides within federation front-end 340; in addition, federated user lifecycle management application 352 is contained within federation front-end 340. In FIG. 7, point-of-contact server 702 is illustrated as residing within the DMZ between firewalls 710 and 712, which form an electronic or physical front-end to the enterprise domain; in addition, federated user lifecycle management application/service 708 resides electronically behind firewall 712. Trust service 714, single-sign-on protocol service 716, and identity-and-attribute service 718 employ enterprise user registry 720 and federation user registry 722 as necessary. The different perspectives of FIG. 3 and FIG. 7 can be reconciled by regarding federation front-end 340 and back-end 330 in FIG. 3 as a logical organization of components while regarding the DMZ and the other components in FIG. 7 as forming a physical or electronic front-end and a physical or electronic back-end, either of which may contain federated components.

Reiterating the roles of a point-of-contact entity/service, the point-of-contact entity provides session management, at least with respect to a user's interaction with the federation functionality with an enterprise's computing environment; applications within a legacy back-end of the enterprise's computing environment may also implement its own session management functionality. Assuming that an enterprise implements policy functionality with respect to the federated computing environment, the point-of-contact entity may act as a policy enforcement point to some other federation partner's policy decision point. In addition, assuming that it is permissible given the implementation of the federation functionality, the point-of-contact entity is responsible for initiating a direction authentication operation against a user in those scenarios in which a single-sign-on operation is not employed. As such, the point-of-contact entity may be implemented in a variety of forms, e.g., as a reverse proxy server, as a web server plug-in, or in some other manner. The point-of-contact functionality may also be implemented within an application server itself, in which case the federated user lifecycle management services may be logically located within the DMZ.

More importantly, referring again to FIG. 7, federated user lifecycle management application 708 also comprises support for interfacing to, interacting with, or otherwise interoperating with federated user lifecycle management plug-ins 724, which are not shown in FIG. 3. In the exemplary architecture that is shown in FIG. 7, federated protocol runtime plug-ins provide the functionality for various types of independently published or developed federated user lifecycle management standards or profiles, such as: WS-Federation Passive Client; and Liberty Alliance ID-FF Single Sign On (B/A, B/P and LECP), Register Name Identifier, Federation Termination Notification, and Single Logout. Different sets of federated protocols may be accessed at different URI's. This approach allows the federated user lifecycle management application to concurrently support multiple standards or specifications of federated user lifecycle management, e.g., the WS-Federation web services specification versus the Liberty Alliance's specifications, within a single application, thereby minimizing the configuration impact on the overall environment for supporting different federation protocols.

More specifically, the appropriate federated user lifecycle management functionality is invoked by the point-of-contact server by redirecting and/or forwarding user requests to the federated user lifecycle management application as appropriate. Referring again to FIG. 7, point-of-contact server 702 receives user requests 730, which are then analyzed to determine the type of request that has been received, which might be indicated by the type of request message that has been received or, as noted above, by determining the destination URI within the request message. While requests 732 for protected resources continue to be forwarded to application servers 704, requests 734 for federated user lifecycle management functions, e.g., requests to invoke a single-sign-off operation, are forwarded to federated user lifecycle management application 708, which invokes the appropriate federated user lifecycle management plug-in as necessary to fulfill the received request. When a new federation protocol or a new federated function is defined, or when an existing one is somehow modified or refined, support can be added simply by plugging a new support module or can be refined by modifying a previously installed plug-in.

The exemplary implementation of a federated user lifecycle management application in FIG. 7 illustrates that the federated user lifecycle management application is able to support multiple, simultaneous, federated user lifecycle management functions while providing a pluggability feature, thereby allowing new functionality to be added to the federated user lifecycle management application in the form of a plug-in when needed without requiring any changes to the existing infrastructure. For example, assuming that the present invention is implemented using a Java™-based federated user lifecycle management application, support for a new federation protocol, such as a newly published single-sign-on protocol, can be added by configuring newly developed Java™ classes to the Java™ CLASSPATH of the federated user lifecycle management application, wherein these new classes support the new standard along with the protocol interface for supporting the present invention.

The exemplary federated architecture leverages the existing environment in which a federated user lifecycle management solution is to be integrated. The federated user lifecycle management application can be easily modified to support new protocols/standards as they evolve with minimal changes to the overall infrastructure. Any changes that might be required to support new federated user lifecycle management functionality are located almost exclusively within the federated user lifecycle management application, which would require configuring the federated user lifecycle management application to understand the added functionality.

There may be minimal configuration changes in other federated components, e.g., at a point-of-contact server, in order to allow the overall infrastructure to be able to invoke new federated user lifecycle management functionality while continuing to support existing federated user lifecycle management functionality. However, the federated user lifecycle management applications are functionally independent from the remainder of the federated components in that the federated user lifecycle management applications may require only minimal interaction with other federated components of the federated environment. For example, in an exemplary embodiment, the federated user lifecycle management functionality may integrate with an enterprise-based datastore, e.g., an LDAP datastore, if federated user lifecycle management information, such as NameIdentifier values in accordance with the Liberty Alliance profiles, are to be stored in an externally-accessible federated user lifecycle management datastore as opposed to a private, internal, federated user lifecycle management datastore that is not apparent or accessible to external entities.

Hence, an existing environment needs minimal modifications to support federated user lifecycle management functionality. Moreover, changes to federated user lifecycle management functionality, including the addition of new functionality, have minimal impact on an existing federated environment. Thus, when a new single-sign-on standard is published, support for this standard is easily added.

Traditional user authentication involves interaction between an enterprise's computing environment and the end-user only; the manner in which the enterprise chooses to implement this authentication interchange is the choice of the enterprise, which has no impact on any other enterprise. When federation or cross-domain single-sign-on functionality is desired to be supported, however, it becomes a requirement that enterprise partners interact with each other. This requirement cannot be done scalably using proprietary protocols. Although adding support for standards-based federation protocols directly to a point-of-contact entity seems like a robust solution, the point-of-contact entity, which is already an existing component within the enterprise's computing environment, must be modified; moreover, it must be modified every time that one of these public federation protocols changes. Moving this functionality out of the point-of-contact entity provides a more modular approach, wherein this pluggable functionality makes it easy to maintain migrations or updates to these protocols.

Enhanced Single-Sign-Off

A user's session is terminated when the user performs a logout or sign-off operation. When a user logs out of a session with a given entity that has acted as an issuing domain, e.g., by performing one or more single-sign-on operations on behalf of the user, then the enterprise should notify any known relying entities, i.e. those domains to which it has performed a single-sign-on operation, in order to initiate a user sign-off or logout at these domains. If any of these relying domains has in turn acted as an issuing domain for the same user, e.g., by performing additional single-sign-on operations, then those relying domains should also notify all of their downstream relying domains about the user logout request in a cascading fashion.

As mentioned previously, single-sign-off solutions have been described within some federation specification standards, such as the WS-Federation specifications and the Liberty Alliance specifications. While they describe how to implement a single-sign-off solution, they do not adequately address how to complete the process; for example, if there are errors in the single-sign-off processing, these specifications do not adequately address how to recover nor how to notify the user of the overall status of the single-sign-off process.

This is problematic because there may be situations when an identity provider, as part of a single-sign-on, assumes liability for a user's actions across a group of federation partners. If the identity provider cannot successfully log a user out of all of this group of partners and cannot notify the user of this status, then the identity provider must retain some level of responsibility for the user's sessions at those partners. This can also be problematic in situations in which a user is accessing a federation relationship through a public Internet kiosk.

In addition, while the Liberty Alliance specifications allow for a service-provider-initiated single logout (SLO), this process requires the service provider to initiate a single logout request at the identity provider and the identity provider to respond with a status of this process to the service provider. This solution does not allow an identity provider to accurately reflect the overall status of the single logout request.

The present invention provides an additional level of information to be collected and communicated during the processing of a single-sign-off process. In the enhanced single-sign-off operation of the present invention, service providers support an additional level of reporting of error status, e.g., beyond a simple success/failure indication, which allows an identity provider to accurately determine the reason for an error during the attempted logout request, thereby enabling an identity provider to differentiate between different reasons for a failure of a logout request. For example, the identity provider is able to distinguish between a failure that has been caused because a session at a service provider could not be terminated and a failure that has been caused because there was no valid active sessions for an identified user, as explained in more detail hereinbelow with respect to the remaining figures. It should be noted that this additional information during a single-sign-off operation may be implemented as an extension to the success/failure status codes that are specified within the Liberty Alliance specifications or the SAML specifications. It should also be noted that, although the examples that are provided hereinbelow rely on HTTP-based communication, a single-sign-off operation may be accomplished with many different types of communication protocols, e.g., SOAP/HTTP directly between domains.

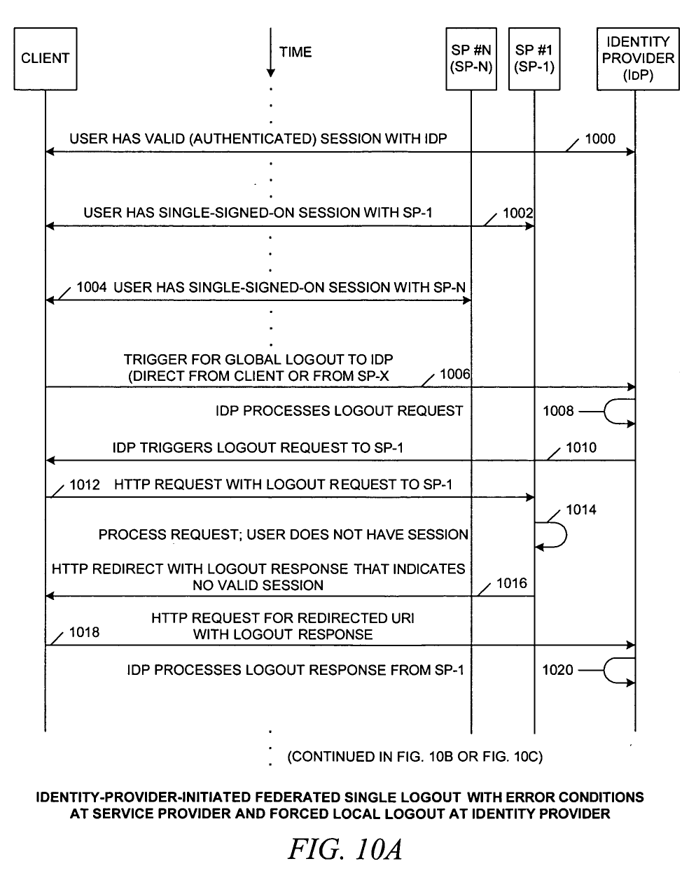

With reference now to FIG. 8, a dataflow diagram depicts an enhanced, identity-provider-initiated, federated single-sign-off operation in accordance with an embodiment of the present invention. The prerequisites for this dataflow are that the user has already authenticated to the identity provider (step 800) at some previous point in time and currently has a valid session with the identity provider; there is no requirement on the reasons for which this session was established. In addition, the user has already authenticated to a service provider (step 802) at some previous point in time and currently has a valid session with the service provider; there is no requirement on the reasons for which this session was established.

At some later point in time, the user requests to perform a logout operation with the identity provider (step 804). The identity provider processes the logout request (step 806) and determines to perform a single-sign-off operation, i.e. single logout operation, on behalf of the user with respect to each service provider that has previously been employed by the identity provider during the user's current session with the identity provider. For example, the identity provider may have performed a series of single-sign-on operations on behalf of the user at multiple service providers, in which case the identity provider would have stored information about each of the service providers in association with the user's session information; the identity provider subsequently attempts to perform a sign-off/logoff/logout operation with each associated service provider.

The single-sign-off operation commences at the identity provider by sending to a first service provider a logout request within an HTTP redirect message (HTTP Response message with status/reason code “302”) via a client, i.e. the user or the user agent, such as a web browser application (step 808). The redirect message redirects the client to the appropriate location, e.g., as identified by a URI within the “Location” header of the redirect message, of the service that is responsible for logout operations at the service provider. This message may have been triggered by several different situations, e.g., in response to an explicit logout request from the user via a web page from the identity provider, or automatically in response to a configurable condition that has been detected by the identity provider.

In response to receiving the redirect message from the identity provider, the client sends an HTTP Get message to the appropriate service at the service provider as indicated by the URI in the HTTP redirect message from the identity provider (step 810). The service provider processes the request message (step 812) and determines the appropriate response; assuming that the user had a valid identity-provider-initiated single-sign-on session at the service provider, i.e. a session at the service provider that was created as a result of a single-sign-on operation that was initiated by the identity provider, the service provider performs a local sign-off operation, thereby successfully terminating the user's session at the service provider.

The service provider sends a logout response within an HTTP redirect message to a client (step 814), wherein the logout response provides an error condition code; in the example that is shown in FIG. 8, the logout operation at the service provider is successful, so the error condition code would indicate that the logout operation at the service provider is successful.

In response to receiving the redirect message from the service provider, the client sends an HTTP Get message to the appropriate service at the identity provider as indicated by the URI in the HTTP redirect message from the service provider (step 816). The redirect message redirects the client to the identity provider using a return URI that was previously provided by the identity provider to the service provider, wherein the return URI is specified in the “Location” HTTP header of the redirect message; alternatively, the service provider has detailed information about the identity provider, such as appropriate URI's of various services, because the identity provider and the service provider share such information as members of a federation.

The identity provider receives and processes the logout response from the service provider (step 818); in the example that is shown in FIG. 8, the logout operation at the service provider has been successful, so the identity provider records that the service provider has reported a successful logout operation. However, the attempt and completion of the logout operation by the identity provider with respect to the service provider may be only one of many such attempted logout operations within a more encompassing single-sign-off operation that is initiated and controlled by the identity provider. As mentioned above, the identity provider has stored information in association with the user's session information about each service provider that may have an active session for the user as known by the identity provider; the identity provider subsequently attempts to perform a sign-off/logoff/logout operation with each associated service provider, in which case the service provider that is involved in steps 808-818 is merely one of many service providers at which the identity provider initiates a logout operation. Hence, the identity provider repeats steps 808-818, either sequentially or concurrently, for the other service providers that may have an active session for the user as known by the identity provider (step 820).

After receiving and recording the logout responses from each of these service providers, the identity provider analyzes all of the logout responses from the service providers (step 822); in the example that is shown in FIG. 8, each service provider is assumed to have reported a successful logout operation. Hence, the identity provider determines that the overall single-sign-off operation has been successful and performs a local logout operation at the identity provider for the user (step 824). The identity provider then sends a response to the client that indicates the successful single-sign-off status (step 826), thereby concluding the single-sign-off process. Any logout status from the identity provider to the user may be branded to refer to the identity provider along with any other service providers that have been involved with the single-sign-off operation.

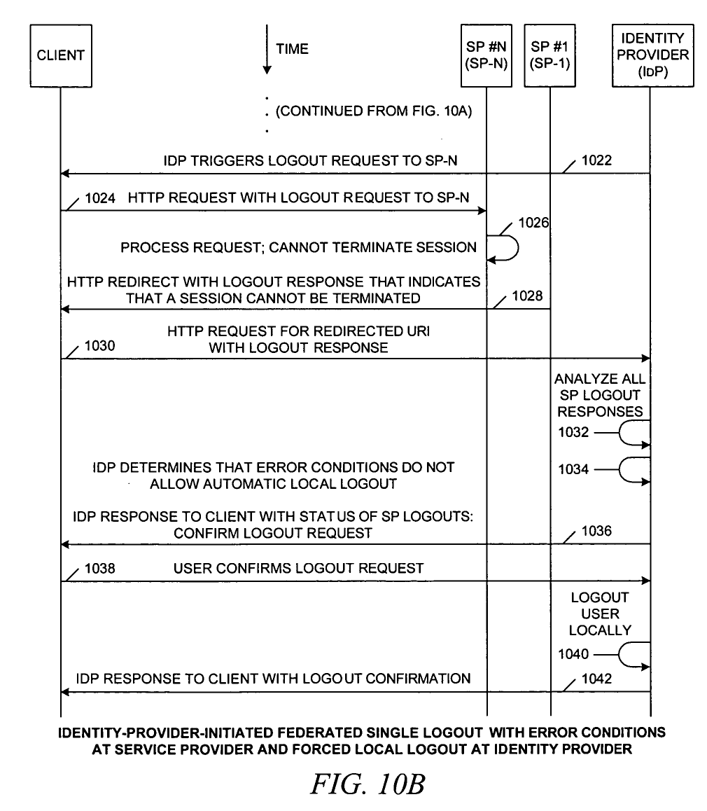

With reference now to FIG. 9, a dataflow diagram depicts an enhanced, service-provider-initiated, federated single-sign-off operation in accordance with an embodiment of the present invention. The prerequisites for this dataflow are that the user has already authenticated to the identity provider (step 900) at some previous point in time and currently has a valid session with the identity provider; there is no requirement on the reasons for which this session was established. In addition, the user has already authenticated to at least one service provider (step 902) at some previous point in time and currently has a valid session with the service provider, which is identified as “Service Provider #1” or “SP-1” in FIG. 9; there is no requirement on the reasons for which this session was established. In contrast with FIG. 8, which shows only a single service provider, FIG. 9 shows multiple service providers, including a service provider which is identified as “Service Provider #N” or “SP-N”.

At some later point in time, the user requests to perform a logout operation with service provider “SP-1” (step 904). The service provider processes the logout request (step 906) and determines to perform a single-sign-off operation, i.e. single logout operation, on behalf of the user with respect to an identity provider and any other service providers that have previously been employed directly by the service provider on behalf of the user during the user's current session with the service provider.

The single-sign-off operation commences at service provider “SP-1” by sending to the identity provider a logout request within an HTTP redirect message (HTTP Response message with status/reason code “302”) via a client, i.e. the user or the user agent, such as a web browser application (step 908). The redirect message redirects the client to the appropriate location, e.g., as identified by a URI within the “Location” header of the redirect message, of the service that is responsible for logout operations at the identity provider. This message may have been triggered by several different situations, e.g., in response to an explicit logout request from the user via a web page from the service provider, or automatically in response to a configurable condition that has been detected by the service provider.

In response to receiving the redirect message from the service provider, the client sends an HTTP Get message to the appropriate service at the identity provider as indicated by the URI in the HTTP redirect message from the service provider (step 910). The identity provider processes the logout request (step 912) and determines to perform a single-sign-off operation, i.e. single logout operation, on behalf of the user with respect to each service provider that has previously been employed by the identity provider during the user's current session with the identity provider. For example, the identity provider may have performed a series of single-sign-on operations on behalf of the user at multiple service providers, in which case the identity provider would have stored information about each of the service providers in association with the user's session information; the identity provider subsequently attempts to perform a sign-off/logoff/logout operation with each associated service provider.

In the example that is shown in FIG. 9, since the logout request originates at a given service provider (“SP-1”), and the logout request is received at the identity provider from the service provider (via the client), the identity provider does not attempt to logout the user from the originating service provider, i.e. service provider “SP-1” in this example. If the originating service provider is the only service provider at which the identity provider has performed a single-sign-on operation on behalf of the user, then the logout operation is nearly complete because the identity provider does not need to request any logout operations at any other service providers; in this case, the identity provider can locally logout the user, terminate the user's session at the identity provider, and then report a successful logout operation to the user.

The single-sign-off operation commences at the identity provider by sending a logout request within an HTTP redirect message (HTTP Response message with status/reason code “302”) via a client, i.e. the user or the user agent, such as a web browser application (step 914), to a first service provider in the set of service providers, which is identified in FIG. 9 as “Service Provider #N” or “SP-N”. The redirect message redirects the client to the appropriate location, e.g., as identified by a URI within the “Location” header of the redirect message, of the service that is responsible for logout operations at service provider “SP-N”.

In response to receiving the redirect message from the identity provider, the client sends an HTTP Get message to the appropriate service at service provider “SP-N” as indicated by the URI in the HTTP redirect message from the identity provider (step 916). The service provider processes the request message (step 918) and determines the appropriate response; assuming that the user had a valid identity-provider-initiated single-sign-on session at the service provider, i.e. a session at the service provider that was created as a result of a single-sign-on operation that was initiated by the identity provider, the service provider performs a local sign-off operation, thereby successfully terminating the user's session at service provider “SP-N”.

It should be noted, though, that a possible error condition code could be generated at this point in time. For example, service provider “SP-N” may determine that it can not logout the user because the identity provider from which it received the logout request did not establish or trigger the creation of the user's session at service provider “SP-N”. In some cases, the service provider or the identity provider may provide information to the user that there is still a valid session with the service provider. For example, the user may be presented with a link to the service provider site, from which the user can directly initiate the logout process.

The service provider sends a logout response within an HTTP redirect message to a client (step 920), wherein the logout response provides an error condition code; in the example that is shown in FIG. 9, the logout operation at the service provider is successful, so the error condition code would indicate that the logout operation at the service provider is successful.

In response to receiving the redirect message from service provider “SP-N”, the client sends an HTTP Get message to the appropriate service at the identity provider as indicated by the URI in the HTTP redirect message from the service provider (step 922). The redirect message redirects the client to the identity provider using a return URI that was previously provided by the identity provider to service provider “SP-N”, wherein the return URI is specified in the “Location” HTTP header of the redirect message; alternatively, the service provider has detailed information about the identity provider, such as appropriate URI's of various services, because the identity provider and the service provider share such information as members of a federation.

The identity provider receives and processes the logout response from service provider “SP-N”; in the example that is shown in FIG. 9, the logout operation at service provider “SP-N” has been successful, so the identity provider records that service provider “SP-N” has reported a successful logout operation. However, the attempt and completion of the logout operation by the identity provider with respect to service provider “SP-N” may be only one of many such attempted logout operations within a more encompassing single-sign-off operation that is initiated and controlled by the identity provider. As mentioned above, the identity provider has stored information in association with the user's session information about each service provider that may have an active session for the user as known by the identity provider; the identity provider subsequently attempts to perform a sign-off/logoff/logout operation with each associated service provider, in which case service provider “SP-N” is merely one of many service providers at which the identity provider initiates a logout operation. Hence, the identity provider, repeats steps 914-922, either sequentially or concurrently, for the other service providers that may have an active session for the user as known by the identity provider (step 924).

After receiving and recording the logout responses from each of these service providers, the identity provider analyzes all of the logout responses from the service providers (step 926); in the example that is shown in FIG. 9, each service provider is assumed to have reported a successful logout operation. Hence, the identity provider determines that the overall single-sign-off operation has been successful and performs a local logout operation at the identity provider for the user (step 928). The identity provider then sends a response to the client that indicates the successful single-sign-off status (step 930), thereby concluding the single-sign-off process.

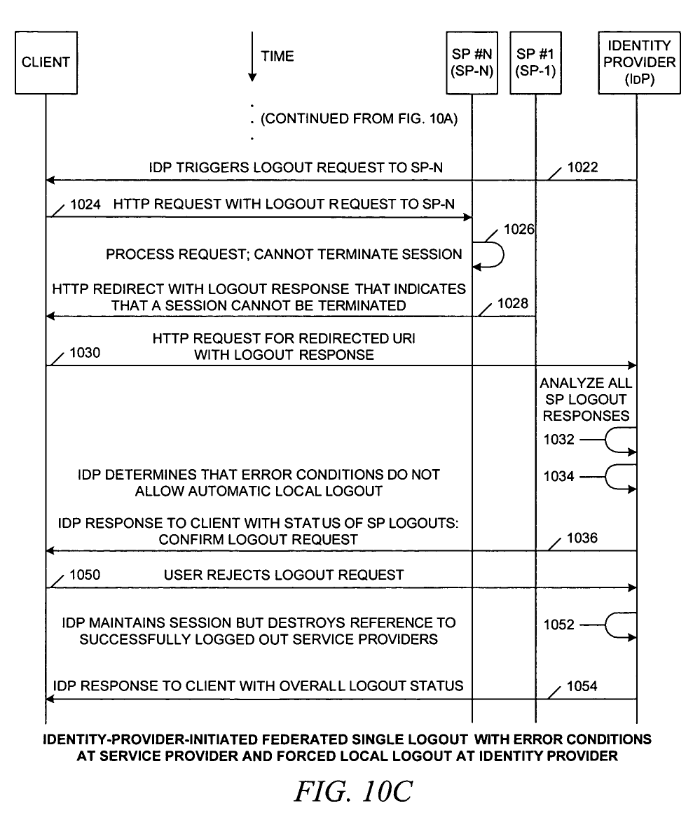

With reference now to FIG. 10A-10C, a dataflow diagram depicts an enhanced, identity-provider-initiated, federated single-sign-off operation wherein the identity provider handles error conditions that are generated during the single-sign-off operation in accordance with an embodiment of the present invention. The dataflow diagram that begins in FIG. 10A logically continues into the dataflow diagram of FIG. 10B or the dataflow diagram of FIG. 10C.

Referring now to FIG. 10A, the prerequisites for this dataflow are that the user has already authenticated to the identity provider (step 1000) at some previous point in time and currently has a valid session with the identity provider, which is identified as identity provider “IdP”; there is no requirement on the reasons for which this session was established. In addition, the user has or has had a valid session with one or more service providers at some previous point in time, e.g., with a first service provider that is identified as “Service Provider #1” or “SP-1” (step 1002) and/or with a second service provider that is identified as “Service Provider #N” or “SP-N” (step 1004); these sessions at the service providers were established as a result of a single-sign-on operation by the identity provider.

At some later point in time, the user requests to perform a logout operation (step 1006); the logout request may be received by the identity provider directly from the user's client or indirectly from a service provider through which the user has already performed a logoff operation. The identity provider processes the logout request (step 1008) and determines to perform a single-sign-off operation, i.e. single logout operation, on behalf of the user with respect to each service provider that has previously been employed by the identity provider during the user's current session with the identity provider. For example, the identity provider may have performed a series of single-sign-on operations on behalf of the user at multiple service providers, in which case the identity provider would have stored information about each of the service providers in association with the user's session information; the identity provider subsequently attempts to perform a sign-off/logoff/logout operation with each associated service provider.

The single-sign-off operation commences at the identity provider by sending a logout request within an HTTP redirect message (HTTP Response message with status/reason code “302”) via a client, i.e. the user or the user agent, such as a web browser application (step 1010), to a first service provider, i.e. service provider “SP-1”. The redirect message redirects the client to the appropriate location, e.g., as identified by a URI within the “Location” header of the redirect message, of the service that is responsible for logout operations at the service provider.

In response to receiving the redirect message from the identity provider, the client sends an HTTP Get message to the appropriate service at service provider “SP-1” as indicated by the URI in the HTTP redirect message from the identity provider (step 1012). The service provider processes the request message (step 1014) and determines the appropriate response. If the user had a valid identity-provider-initiated single-sign-on session at the service provider, i.e. a session at the service provider that was created as a result of a single-sign-on operation that was initiated by the identity provider, then the service provider would perform a local sign-off operation. However, in the example that is shown in FIG. 10A, the service provider determines that although the user does have a valid session, this session was not established via a single-sign-on operation from the requesting identity provider; hence, the service provider can not destroy the user's session at the service provider based on the received logout request from the identity provider.

The service provider sends a logout response within an HTTP redirect message to a client (step 1016), wherein the logout response provides an error condition code; in the example that is shown in FIG. 10A, the logout operation at the service provider has been unsuccessful, so the error condition code would indicate that the logout operation at service provider “SP-1” is unsuccessful. As explained in more detail hereinbelow, the error condition code provides secondary information as to the reason why the logout operation at service provider “SP-1” has been unsuccessful so that the identity provider may perform subsequent operations in a manner that is guided by the indicated error, e.g., in accordance with an error code that indicates that the service provider did not have a valid session for the user.

In response to receiving the redirect message from service provider “SP-1”, the client sends an HTTP Get message to the appropriate service at the identity provider as indicated by the URI in the HTTP redirect message from the service provider (step 1018). The redirect message redirects the client to the identity provider using a return URI that was previously provided by the identity provider to the service provider, wherein the return URI is specified in the “Location” HTTP header of the redirect message; alternatively, the service provider has detailed information about the identity provider, such as appropriate URI's of various services, because the identity provider and the service provider share such information as members of a federation.

The identity provider receives and processes the logout response from service provider “SP-1” (step 1020); in the example that is shown in FIG. 10A; the logout operation at service provider “SP-1” has been unsuccessful, so the identity provider records that the service provider has reported an unsuccessful logout operation.

The attempt and completion of the logout operation by the identity provider with respect to the service provider may be only one of many such attempted logout operations within a more encompassing single-sign-off operation that is initiated and controlled by the identity provider. As mentioned above, the identity provider has stored information in association with the user's session information about each service provider that may have an active session for the user as known by the identity provider; the identity provider subsequently attempts to perform a sign-off/logoff/logout operation with each associated service provider, in which case service provider “SP-1” that is involved in steps 1010-1020 is merely one of many service providers at which the identity provider initiates a logout operation. Hence, the identity provider repeats steps 1010-1020, either sequentially or concurrently, for the other service providers that may have an active session for the user as known by the identity provider.

Referring now to FIG. 10B, the single-sign-off operation continues at the identity provider by sending a logout request within an HTTP redirect message (HTTP Response message with status/reason code “302”) via a client, i.e. the user or the user agent, such as a web browser application (step 1022), to a second service provider, i.e. service provider “SP-N”. The redirect message redirects the client to the appropriate location, e.g., as identified by a URI within the “Location” header of the redirect message, of the service that is responsible for logout operations at the service provider.

In response to receiving the redirect message from the identity provider, the client sends an HTTP Get message to the appropriate service at service provider “SP-N” as indicated by the URI in the HTTP redirect message from the identity provider (step 1024). The service provider processes the request message (step 1026) and determines the appropriate response. If the user had a valid session at the service provider, then the service provider would perform a local sign-off operation. However, in the example that is shown in FIG. 10B, the service provider determines that, for some reason, it is not able to terminate the user's session; e.g., the service provider may have initiated a time-consuming, synchronous, uninterruptable, transaction at a different service provider such that the service provider must wait for the completion of the transaction before performing additional operations on the user's session.

The present invention may be implemented in conjunction with a variety of implementations for enhanced response indication codes. In a preferred embodiment, a success response code indicates that a user had a valid identity-provider-initiated single-sign-on session at a service provider and that the session and its associated state information has been destroyed in response to a logout request. A failure response code may be indicated through the simultaneous use of a major code and a minor code in which the event of a failure is indicated by the major code and the reason for the failure is indicated by the minor code; alternatively, a single error value may be provided. In a scheme that employs a major code and a minor code, various minor codes may be used.

For example, a minor code may be used to indicate “NoSessionToDestroy”, which would indicate that there was no valid session for the user; from the perspective of the identity provider, the result is equivalent to a successful logout because the service provider does not have an active session for the user, so the identity provider does not need to be concerned about its responsibility to cleanup or secure any user-specific computational resources that might be vulnerable to abuse by a malicious user. Any service provider that returns a “NoSessionToDestroy” status code would preferably be reported to the user as having completed a successful logout operation.

Another exemplary minor code may be used to indicate “ValidSessionStillExistsSP”, which would indicate that there remains a valid session for the user at the service provider because the service provider was not able to logout the user; from the perspective of the identity provider, the result represents a failure because the identity provider needs to remain concerned about the ability of a malicious user to abuse the active session. In a case in which a major code is returned that indicates a failure without a minor code, then the identity provider may act as if a minor code such as “ValidSessionStillExistsSP” so that the identity provider may continue to perform actions to ensure that the user has been properly logged out by a service provider. Any service provider that returns a “ValidSessionStillExistsSP” status code would preferably be reported to the user as having completed a failed logout operation.

Other minor codes may also be implemented. For example, a minor code may be used to indicate “NoSessionSSOFromThisIDP”, which would indicate that the service provider has a valid session for the user but that it was not an identity-provider-initiated single-sign-on session from the requesting identity provider; hence, the service provider could not fulfill the request from the identity provider.

From the perspective of the identity provider, the result represents a failure because the identity provider needs to remain concerned about the ability of a malicious user to abuse the active session at the service provider. In response to receiving a “NoSessionSSOFromThisIDP” status code, the identity provider would preferably report the failed logout operation to the user; in addition, the identity provider should provide a warning to the user that the identity provider will never be able to logout the user's session at the service provider using a single-logout request from the identity provider.

In a preferred embodiment, as a result of the receipt of the “NoSessionSSOFromThisIDP” status code, the identity provider would present to the user a mechanism for allowing the user to initiate a logout operation directly with the service provider. For example, the identity provider would send to the user's client a web page with an embedded hyperlink that the user could select to visit the service provider's web site. In one alternative, the hyperlink is tied directly to a logout resource at the service provider such that user's selection of the hyperlink generates a request message that is sent to the service provider for a logout of the user's session at the service provider; in response to recognizing the logout request as having originated directly from the user's client, the service provider would immediately initiate a logout operation on the user's session at the service provider. In another alternative, the hyperlink that was provided by the identity provider requests yet another web page, albeit from the service provider rather than the identity provider; the service provider would return the requested web page to the user's client, and the requested web page would contain a hyperlink that the user may select to request a logout of the user's session at the service provider. In response to recognizing the logout request as having originated directly from the user's client, the service provider would immediately initiate a logout operation on the user's session at the service provider.

The service provider sends a logout response within an HTTP redirect message to a client (step 1028), wherein the logout response provides an error condition code; in the example that is shown in FIG. 10B, the logout operation at the service provider has been unsuccessful, so the error condition code would indicate that the logout operation at service provider “SP-N” is unsuccessful. As explained in more detail hereinbelow, the error condition code provides secondary information as to the reason why the logout operation at service provider “SP-N” has been unsuccessful so that the identity provider may perform subsequent operations in a manner that is guided by the indicated error, e.g., in accordance with an error code that indicates that the service provider could not terminate a session for the user.

In response to receiving the redirect message from service provider “SP-N”, the client sends an HTTP Get message to the appropriate service at the identity provider as indicated by the URI in the HTTP redirect message from the service provider (step 1030). The redirect message redirects the client to the identity provider using a return URI that was previously provided by the identity provider to the service provider, wherein the return URI is specified in the “Location” HTTP header of the redirect message; alternatively, the service provider has detailed information about the identity provider, such as appropriate URI's of various services, because the identity provider and the service provider share such information as members of a federation.

The identity provider receives and processes the logout response from service provider “SP-N”; in the example that is shown in FIG. 10B, the logout operation at service provider “SP-N” has been unsuccessful, so the identity provider records that the service provider has reported an unsuccessful logout operation.

After receiving and recording the logout responses from each service provider, the identity provider analyzes all of the logout responses from the service providers (step 1032); in the example that is shown in FIGS. 10A-10B, all service providers, i.e. service providers “SP-1” and “SP-N”, have reported an unsuccessful logout operation. Hence, the identity provider determines that it cannot perform an automatic local logout for the user at the identity provider (step 1034) because at least one error condition that has been reported by a service provider.

In the example that is provided in FIG. 10B, given that there has been at least one error condition with which the identity provider should remain concerned because it prevents an overall successful single-sign-off, the identity provider maintains the active session for the user so that the identity provider can continue a dialog with the user in order to determine the preferred subsequent action of the user with respect to the unsuccessful single-sign-off operation. The identity provider sends a response to the client that indicates the status of the logout operation (step 1036), particularly with respect to the service providers that have reported unsuccessful logout responses.

It should be noted that, as explained above, various error conditions may be supported, and the error conditions are not necessarily equivalent. For example, a supported error condition code may indicate that the service provider cannot logout a user as requested by an identity provider because the identity provider did not cause the creation of the user's active session, yet a receipt of this error code should not prevent the identity provider from logging out the user with respect to the identity provider. However, the identity provider cannot consider this error condition as a success; otherwise, the user might be led to assume or to believe that the user does not have a valid session at the service provider, which is not true. Hence, it should be noted that the identity provider should be able to handle different classes of error codes in different manners; some of the error codes that are received by the identity provider are strictly indicative of the success or the failure of fulfilling the logout request at the service provider, while other error codes are indicative of the success of destroying a user's session at the service provider. Some of these error codes may require that the identity provider provide additional information about the error condition to a user while not impeding the completion of the single-sign-off operation at the identity provider. Other error codes may require that the identity provider determine that the overall single-sign-off operation has been unsuccessful such that the identity provider needs to maintain the active session for the user so that the identity provider can continue a dialog with the user in order to determine the preferred subsequent action of the user with respect to the unsuccessful single-sign-off operation.

As explained in more detail hereinbelow, the user is provided with various options for handling the unsuccessful logouts; as shown in FIG. 10B, the identity provider sends a response to the client that provides the user with the opportunity to confirm the logout request at step 1036. After the user confirms the logout request (step 1038) by returning a message, e.g., which might be generated when the user selects a hyperlink in the confirmation message from the identity provider or when the user pushes a form button in the confirmation message, the identity provider performs a logout operation for the user (step 1040) and terminates the user's session at the identity provider. The identity provider then sends a response message to the client with a logout confirmation for the user (step 1042), thereby concluding the process that is shown in FIG. 10B.

FIG. 10C is similar to FIG. 10B in that, given that there has been at least one error condition, the identity provider determines that the overall single-sign-off operation has been unsuccessful, and the identity provider maintains the active session for the user so that the identity provider can continue a dialog with the user in order to determine the preferred subsequent action of the user with respect to the unsuccessful single-sign-off operation. The identity provider sends a response to the client that indicates the status of the logout operation (step 1036), particularly with respect to the service providers that have reported unsuccessful logout responses.

In contrast to FIG. 10B, the example in FIG. 10C illustrates that the user rejects the logout request from the identity provider (step 1050) by returning a message, e.g., which might be generated when the user selects a hyperlink in the confirmation message from the identity provider or when the user pushes a form button in the confirmation message. Given that the user has not allowed the identity provider to continue with the logout operation, the identity provider maintains the user's session at the identity provider but destroys its references to any service providers from which the user has been successfully logged out during the single-sign-off operation (step 1052) so that these service providers do not receive any logout requests thereafter. In this manner, the identity provider continues to maintain information about any service providers at which the user has not been successfully logged out such that the identity provider may assist the user with respect to these service providers, as explained hereinbelow. It should be noted that the identity provider would also remove any references to any service providers for which the identity provider was not able to logout the user because the user did not have a currently valid identity-provider-initiated single-sign-on session, e.g., in response to having received a “NoSessionSSOFromThisIDP” error condition code; in this manner, the identity provider would not subsequently attempt to issue a single-logout request to a service provider at which the identity provider is aware that the user does not have a valid identity-provider-initiated single-sign-on session from the identity provider. The identity provider then sends a response message to the client (step 1054), thereby concluding the process that is shown in FIG. 10C.

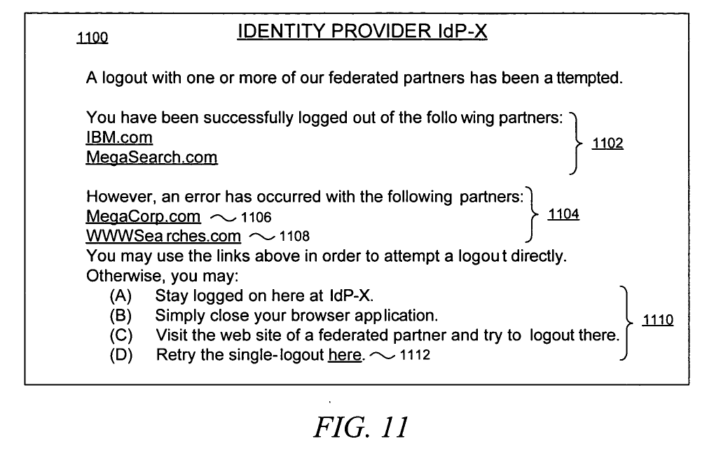

With reference now to FIG. 11, an information window within a graphical user interface is presented in which an identity provider informs a user of the status of a single-sign-off operation based on enhanced error code values that have been returned by one or more service providers during the single-sign-off operation in accordance with the present invention. An information window may be a dialog box or dialog window that is presented to a user of a client; in the example that is shown in FIG. 11, information window 1100 is a web page that is presented to the user within a browser application that has received the web page as content within a response message from an identity provider. The information can be graphically branded to indicate that the information is provided on behalf of a federation of web sites, particularly the web sites that have acted as service providers for transactions that have just been performed on behalf of the user.

Text portion 1102 of information window 1100 informs the user about the federation partners from which the user has been successfully logged out during a single-sign-off operation. The federation partners that are shown in text portion 1102 are those service providers that have reported a successful logout status code or its equivalent to the identity provider in response to a logout request from the identity provider during a single-sign-off operation.

Text portion 1104 of information window 1100 informs the user about the federation partners at which the user has not been successfully logged out during a single-sign-off operation. The federation partners that are shown in text portion 1104 are those service providers that have reported an unsuccessful or failed logout status code or its equivalent to the identity provider in response to a logout request from the identity provider during a single-sign-off operation. In the example that is shown in FIG. 11, the names of the federation partners in text portion 1104 are presented as selectable controls, e.g., hyperlinks 1106 and 1108, that the user may use to access resources at the federation partners. In one embodiment, if the user selects a hyperlink, another browser window may be opened, and the newly opened browser window would be directed to a particular resource at the selected federation partner, e.g., a web page from which the user may manually select a logout button or logout hyperlink, thereby directly requesting a logout operation from the user's client to the federation partner's server.

Text portion 1110 of information window 1100 informs the user about the various alternative actions that the user may take in view of the reported error. One of the alternative actions that may be taken by a user may be represented by a mechanism that allows a user to re-attempt or retry to perform a single-logout operation as controlled by the identity provider, e.g., as represented by hyperlink 1112 that may be selected by the user. In response to receiving a request based on the user's selection of hyperlink 1112, the identity provider would perform the single-logout again, particularly with the view that the second attempt to logoff the user at certain service providers may be successful because various types of errors may have occurred internally at the service provider that prevents the successful completion of the first logoff request for the user.

Conclusion

The advantages of the present invention should be apparent in view of the detailed description of the invention that is provided above. The present invention extends the amount of error information that is reported and processed during a single-sign-off operation, thereby allowing an identity provider or other entity to accurately report logout status to a user so that the user may take an appropriate action. The user may also be provided with a mechanism to manually or directly attempt to force a logout at a recalcitrant service provider that has reported an error during the single-sign-off operation; at a minimum, the user may be informed that the user may have active sessions at federated partners such that the user should close the user's client agent, e.g., browser application, in order to terminate any active sessions at the federated partners.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for managing user sessions within a distributed data processing system, the method comprising:
identifying, in response to determining to logoff a user at a first domain, a second domain at which the first domain has participated in a single-sign-on operation on behalf of the user;
sending, from a system in the first domain to a system in the second domain, a logoff request message in order to logoff the user at the second domain; and
receiving a logoff response message at a system in the first domain from a system in the second domain, wherein the logoff response message contains at least one error code that indicates information about a reason for a failure to logoff the user at the second domain.

2. The method of claim 1 further comprising:
sending a response message to a client, wherein the response message contains information to inform the user about the failure to logoff the user at the second domain.

3. The method of claim 2 further comprising:
inserting a selectable control within the response message, wherein the selectable control can be selected by the user to attempt a logout operation directly from the client to the second domain.

4. The method of claim 1 further comprising:
receiving, at the first domain from a client, a message that represents a request for a single-logoff operation on behalf of the user with respect to domains at which the first domain has participated in a single-sign-on operation on behalf of the user.

5. The method of claim 4 further comprising:
sending a response message to a client, wherein the response message contains information to inform the user about the failure to logoff the user at the second domain; and
inserting a selectable control within the response message, wherein the selectable control can be selected by the user to re-attempt the single-logoff operation.

6. The method of claim 1 further comprising:
generating a list of domains with which the first domain has participated in a single-sign-on operation on behalf of the user;
sending, from a system in the first domain to a system in each domain in the list of domains, a logoff request message in order to logoff the user at each domain in the list of domains; and
receiving logoff response messages at a system in the first domain from systems in the list of domains, wherein the logoff response messages contain at least one error code that indicates information about a reason for a failure to logoff the user at a domain in the list of domains.

7. The method of claim 6 wherein the second domain is in the list of domains with which the first domain has participated in a single-sign-on operation on behalf of the user.

8. The method of claim 6 wherein the second domain is not in the list of domains with which the first domain has participated in a single-sign-on operation on behalf of the user.

9. The method of claim 1 further comprising:
receiving at a system in the first domain a request from a client operated by the user to initiate a logoff operation; and
determining to logoff the user based on the request from the user.

10. The method of claim 1 further comprising:
receiving at a system in the first domain a logoff request message from a system in the second domain to initiate a logoff operation for the user; and
determining to logoff the user based on the request from a system in the second domain.

11. The method of claim 1 further comprising:
receiving at a system in the first domain a logoff request message from a system in a third domain to initiate a logoff operation for the user; and
determining to logoff the user based on the request from a system in the third domain.

12. The method of claim 11 further comprising:
generating a list of domains with which the first domain has participated in a single-sign-on operation on behalf of the user, wherein the second domain is in the list of domains with which the first domain has participated in a single-sign-on operation on behalf of the user but wherein the third domain is not in the list of domains with which the first domain has participated in a single-sign-on operation on behalf of the user;
sending, from a system in the first domain to a system in each domain in the list of domains, a logoff request message in order to logoff the user at each domain in the list of domains; and
receiving logoff response messages at a system in the first domain from systems in the list of domains, wherein the logoff response messages contain at least one error code that indicates information about a reason for a failure to logoff the user at a domain in the list of domains.

13. The method of claim 11 wherein the first domain is an identity provider and the third domain is a service provider.

14. The method of claim 1 wherein the first domain is an identity provider and the second domain is a service provider.

15. A computer program product on a computer readable medium for use in a data processing system for managing user sessions, the computer program product comprising:
means for identifying, in response to determining to logoff a user at a first domain, a second domain at which the first domain has participated in a single-sign-on operation on behalf of the user;
means for sending, from a system in the first domain to a system in the second domain, a logoff request message in order to logoff the user at the second domain; and
means for receiving a logoff response message at a system in the first domain from a system in the second domain, wherein the logoff response message contains at least one error code that indicates information about a reason for a failure to logoff the user at the second domain.

16. The computer program product of claim 15 further comprising:
means for sending a response message to a client, wherein the response message contains information to inform the user about the failure to logoff the user at the second domain; and
means for inserting a selectable control within the response message, wherein the selectable control can be selected by the user to attempt a logout operation directly from the client to the second domain.

17. The computer program product of claim 15 further comprising:
means for receiving, at the first domain from a client, a message that represents a request for a single-logoff operation on behalf of the user with respect to domains at which the first domain has participated in a single-sign-on operation on behalf of the user.

18. The computer program product of claim 17 further comprising:
means for sending a response message to a client, wherein the response message contains information to inform the user about the failure to logoff the user at the second domain; and
means for inserting a selectable control within the response message, wherein the selectable control can be selected by the user to re-attempt the single-logoff operation.

19. The computer program product of claim 15 further comprising:
means for generating a list of domains with which the first domain has participated in a single-sign-on operation on behalf of the user;
means for sending, from a system in the first domain to a system in each domain in the list of domains, a logoff request message in order to logoff the user at each domain in the list of domains; and
means for receiving logoff response messages at a system in the first domain from systems in the list of domains, wherein the logoff response messages contain at least one error code that indicates information about a reason for a failure to logoff the user at a domain in the list of domains.

20. An apparatus for managing user sessions in a distributed data processing system, the computer program product comprising:
means for identifying, in response to determining to logoff a user at a first domain, a second domain at which the first domain has participated in a single-sign-on operation on behalf of the user;
means for sending, from a system in the first domain to a system in the second domain, a logoff request message in order to logoff the user at the second domain; and
means for receiving a logoff response message at a system in the first domain from a system in the second domain, wherein the logoff response message contains at least one error code that indicates information about a reason for a failure to logoff the user at the second domain.
